(19) United States
(12) Patent Application Publication
(10) Pub. No.: US 2025/0137563 A1
(43) Pub. Date: May 1, 2025

(54) Waxless Toilet Seal

(71) Applicant: Danco, Inc., Irving, TX (US)

(72) Inventors: Casey J. Fregoe, The Colony, TX (US); Robert C. Jones, JR., Rockwall, TX (US)

(21) Appl. No.: 18/931,651

(22) Filed: Oct. 30, 2024

Related U.S. Application Data
(60) Provisional application No. 63/594,590, filed on Oct. 31, 2023.

(51) Int. Cl. F16L 23/22; E03D 11/16

(52) U.S. Cl. CPC F16L 23/22; E03D 11/16

(57) ABSTRACT

Seals comprising a height adjustable sealing surface are disclosed to facilitate a fluid tight connection between two components, such as a toilet and a closet collar. The adjustable height accommodates variable spacing, allowing the seal to be used with multiple component arrangements. A seal comprises a first threaded body with a flange configured to connect to and be supported by one of the components, such as a closet collar, and a second threaded body with a sealing surface configured to receive the second component, such as a toilet horn. The second threaded body engages with the first threaded body to allow height adjustment by rotating the body. A dual thread start configuration may be used for the threaded bodies. A sweep seal may be disposed on an exterior surface of the second threaded body to aid in optimal compression and avoiding compression set in creating a fluid tight seal.

### CROSS REFERENCE TO RELATED APPLICATION

This application claims the benefit of U.S. provisional patent application No. 63/594,590 filed Oct. 31, 2023.

### FIELD OF THE DISCLOSURE

The present disclosure relates generally to a sealing device for use between two components in fluid communication with each other to accommodate different spacing, height, or depth differences between the components. More particularly, the present disclosure relates to a waxless sealing device for use with a toilet and toilet closet collar that accommodates varying closet collar installation depths.

### BACKGROUND OF THE DISCLOSURE

Toilet seals are used to facilitate a fluid tight connection or seal between a toilet and a closet collar. A closet collar (or closet flange) is installed in a drainpipe and provides a transition and point of connection between a toilet and a drainpipe to allow sewage to enter a sewage system, with a toilet seal disposed to provide a seal between the toilet and closet collar. Traditionally, a wax ring has been used as a toilet seal. Installation of the wax ring can be messy, the seal created is not very strong, and they are prone to failure over time.

Installation practices of a closet collar in a drainpipe can also vary, with some closet collars being installed level with the flooring, some on top of or above the flooring, while others may be recessed with respect to the flooring, such as on a subfloor or even directly on the foundation. These varying installation practices often make it difficult to install a toilet and toilet seal properly. The toilet is designed to sit on the floor surface surrounding the closet collar and there is frequently a height difference between an upper surface of the collar and the floor surface due to the variations in installation of the closet collar. The typically used wax ring toilet seals come in two standard sizes, one being thicker (or higher) than the other. Multiple wax rings can be stacked together to accommodate more variance in the height distance, but that only compounds the drawbacks associated with possible failure of the seal. The wax rings also still have limited ability to accommodate differing heights between the collar and surrounding floor surface on which the toilet will sit.

Devices that allow for installation at varying closet collar depths are known in the art. For example, U.S. Pat. No. 11,274,429 discloses a sealing assembly that has a toilet horn receptacle disposed above a funnel, both surrounded by a raised exterior channel wall. A sealing component, such as a wax ring, can be placed in a channel formed between an interior of the channel wall and an exterior of the receptacle and funnel. The assembly is compressible so that when a toilet is positioned in the toilet horn receptacle and lowered to the floor surface, it pushes the receptacle and funnel downward into the closet collar and pushes the channel wall inward and downward relative to their initial, uncompressed positions. The '429 patent further discloses an additional adapter component that is insertable into the sealing assembly to accommodate larger height differences. Although the '942 patent provides many advantages, it still requires a sealing component, which in use is typically an undesirable wax ring. The '942 patent also does not include any structure to aid in holding closet bolts in an upright position during installation of the toilet. The closet bolts connect the toilet to the closet collar. During installation of the toilet, the toilet has to be lowered over the bolts, aligning the bolts with apertures in the toilet base. The bolts have a tendency to tilt if not securely held in an upright position, which can make aligning the apertures in the toilet base difficult.

As another example, U.S. Pat. No. 10,100,505 discloses a toilet seal with an upper sealing flange, an elongated sleeve that extends through the drainpipe, a series of sealing elements around a lower end of the sleeve to seal to the drainpipe, and a series of removable rings disposed around an upper end of the sleeve and below the sealing flange. The rings are selectively removable to allow more of the sleeve to move down into drainpipe, shortening the distance between the sealing flange and top of the closet collar, to accommodate different distances. While helpful in allowing use with different distances, the removable rings provide a point of failure, as they could be broken away from the sleeve during installation or subsequent use (particularly if the toilet needs to be plunged), which could impact the seal.

The '505 patent also discloses other embodiments with a fixed ring disposed around the sleeve below the sealing flange. Separate toilet seals with different placement of the fixed ring (closer to or farther from the sealing flange) are required to accommodate different closet collar distances. The fixed ring is not intended to be removable, which resolves the potential failure issue, but does not provide the flexibility to accommodate different distances because one toilet seal is not usable for multiple different distances. Additionally, with either embodiment in the '505 patent, the distance between the sealing flange and each of the removable rings or the fixed ring is a set value. Therefore, there may be issues with achieving a proper and strong seal if the actual distance between the floor surface and the closet collar falls outside of a tolerance range for the set value.

There remains a need for fluid communication sealing devices that provide adjustability and flexibility in accommodating different distances or spacing between two components in fluid communication with each other, such as a sink and drainpipe or toilet and closet collar/drainpipe, that does not require the use of a wax seal, that is less prone to failure issues, and that provides consistent sealing ability for positive and negative pressure situations (such as may be encountered when plunging a clogged toilet) over its full range of height/spacing adjustability.

### BRIEF DESCRIPTION OF THE DRAWINGS

For a more complete understanding of the present disclosure and so that the manner in which the features and advantages of preferred embodiments can be understood in more detail, reference is now made to the following brief description, taken in connection with the accompanying drawings and detailed description.

FIG. 1 shows side elevation exploded view of a seal assembly according to a preferred embodiment of the disclosure along with a typical closet collar.

FIG. 2 shows a top plan view of a lower seal according to a preferred embodiment.

FIG. 3 shows aside elevation view of the lower seal of FIG. 2.

FIG. 4 shows a cross-sectional side elevation view of the lower seal of FIG. 3.

FIG. 5 shows an enlarged portion of FIG. 4.

FIG. 6A shows a top plan view of a lower threaded support according to a preferred embodiment.

FIG. 6B shows an enlarged portion of FIG. 6A.

FIG. 7 shows a side elevation view of the lower threaded support of FIG. 6A.

FIG. 8A shows a cross-sectional side elevation view of the lower threaded support of FIG. 7.

FIG. 8B shows an enlarged portion of FIG. 8A.

FIG. 9A shows another enlarged portion of FIG. 8A with cross-sectional hatch marks removed for ease of viewing.

FIG. 9B shows an interior profile contour of a thread from the lower threaded support of FIG. 9A.

FIG. 9C shows the interior profile contour of FIG. 9B with the labels removed for ease of viewing.

FIG. 10A shows a cross-sectional side elevation view of the lower threaded support of FIG. 6A.

FIG. 10B shows an enlarged portion of FIG. 10A.

FIG. 11 shows a perspective view from the top of an upper main seal according to a preferred embodiment.

FIG. 12 shows a top plan view of the upper main seal of FIG. 11.

FIG. 13A shows a cross-sectional side elevation view of the upper main seal of FIG. 12.

FIG. 13B shows an enlarged portion of FIG. 13A.

FIG. 13C shows an enlarged portion of FIG. 13A.

FIG. 14 shows a side elevation view of the upper main seal of FIG. 11.

FIG. 15A shows a cross-sectional side elevation view of the upper main seal of FIG. 14 taken through a section with sweep seals according to a preferred embodiment.

FIG. 15B shows an enlarged portion of FIG. 15A.

FIG. 16 shows a bottom plan view of the upper main seal of FIG. 11.

FIG. 17 shows a perspective view from the bottom of the upper main seal of FIG. 11.

FIG. 18 a top plan view of an insert for an upper main seal according to a preferred embodiment.

FIG. 19 shows a side elevation view of the insert of FIG. 18.

FIG. 20 shows a cross-section side elevation view of the insert of FIG. 19.

FIG. 21 shows a perspective view from the top of the seal assembly of FIG. 1 in one embodiment of an assembled state and connected to a typical closet collar.

FIG. 22 shows a cross-sectional side elevation exploded view of FIG. 21.

FIG. 23 shows a cross-sectional side elevation of FIG. 22 in one embodiment of an assembled state and connected to a typical closet collar.

FIG. 24 shows a cross-section side elevation view of the seal assembly of FIG. 1 in one embodiment of an assembled state and connected to a toilet and typical closet collar installed above floor level.

FIG. 24A is an enlarged portion of FIG. 24.

FIG. 25 shows a cross-section side elevation view of the seal assembly of FIG. 1 in one embodiment of an assembled state and connected to a toilet and typical closet collar installed at floor level.

FIG. 25A is an enlarged portion of FIG. 25.

FIG. 26 shows a cross-section side elevation view of the seal assembly of FIG. 1 in one embodiment of an assembled state and connected to a toilet and typical closet collar installed below floor level.

FIG. 26A is an enlarged portion of FIG. 26.

FIG. 26B is another enlarged portion of FIG. 26.

The use of the same reference symbols in different drawings indicates similar or identical items.

### SUMMARY

In some embodiments, a seal for creating a fluid-tight and height or spacing adjustable seal between two components in fluid communication with each other comprises a lower threaded support comprising a first threaded body and an upper main seal comprising a sealing surface and a second threaded body extending downwardly from the sealing surface. The first threaded body is configured to engage with the second threaded body to allow a position of the sealing surface to be selectively raised or lowered relative to the lower threaded support by rotating one of the first threaded body or the second threaded body relative to the other of the first threaded body or the second threaded body. The lower threaded support is preferably configured to engage with a first of the components being connected by the seal, such as a closet collar. The upper main seal is preferably configured to engage with a second of the components being connected by the seal, such as a toilet horn.

In some embodiments, a seal further comprises a lower seal configured to receive at least a portion the lower threaded support and be disposed between the lower threaded support and the first component. In some other embodiments, a lower seal is integrally formed with a lower threaded support.

In some embodiments, an upper main seal further comprises an upper body disposed between a sealing surface and a second threaded body. In still other embodiments, an upper main seal further comprises a rigid threaded insert and a second threaded body is overmolded on the rigid insert. In still other embodiments, an upper main seal further comprises one or more sweep seals disposed on an exterior surface of a second threaded body. Preferably, there are multiple sets of sweep seals spaced apart circumferentially and/or vertically on a second threaded body. In some other embodiments, a second threaded body comprises threads having a dual thread start configuration, preferably having a thread pitch of around 0.3333 to 1.33334 inches. According to other embodiments, a first threaded body comprises threads that are configured to engage or mate with threads on a second threaded body. In other embodiments, a first threaded body comprises threads having a dual thread start configuration, preferably having a thread pitch of around 0.3333 to 1.33334 inches.

In some embodiments, a lower threaded support further comprises a flange configured to engage with the first component, preferably to prevent rotation of the lower threaded support within the first component. In some embodiments, a flange comprises one or more apertures that align with apertures on the first component to receive a connecting component, such as a bolt. In other embodiments, the one or more apertures on the flange also align with apertures on the second component to aid in connecting the first component to the second component with the flange disposed between them. In some embodiments, a lower threaded support may further comprise a central body. A central body may be disposed above a first threaded body and may extend below a flange, if included. In still other preferred embodiments, a central body may be configured to receive at least a portion, and more preferably substantially all of, an upper body of an upper main seal. In some embodiments, a lower seal may be configured to receive at least a portion, and most preferably substantially all of, a central body of a lower threaded support.

In some embodiments, a central body of a lower threaded support and lower seal, if included, are configured to receive, fit within, and/or engage with the first component. In some embodiments, an upper body of an upper main seal is configured to receive, fit within, and/or engage with a central body of lower threaded support. In some preferred embodiments where the first component is a closet collar having a frustoconical interior surface, a central body has a frustoconical shape that is sized to fit within the closet collar and an upper body has a frustoconical shape that is configured to fit within central body. In still other preferred embodiments, an upper body may be made of flexible material that deforms to fit with a central body. A lower seal, if included, may also have a frustoconical shape that is sized to fit within the closet collar.

In some embodiments, a sealing surface of upper main seal is configured to receive, fit within, and/or engage with the second component. In some preferred embodiments where the second component is a toilet horn having a substantially cylindrical shape, a sealing surface comprises an annular ring that is preferably configured to conform to an exterior surface shape of the toilet horn.

In some preferred embodiments, one or more sealing ribs or sealing ridges are disposed on a sealing surface of upper main seal and/or an exterior surface of a lower seal. Sealing ribs or ridges provide additional sealing against the second component or against an interior surface of the first component, respectively.

A seal according to preferred embodiments herein is capable of creating a fluid-tight seal between the first and second components without requiring the use of a wax ring or wax seal. A seal according to preferred embodiments herein is also capable of being height or spacing adjustable to accommodate different heights or spacing between the first and second components by rotating an upper main seal and a lower threaded support relative to each other to engage more of their threads or fewer of their threads.

In some preferred embodiments, an upper main seal is selectively installed in a first position or fully engaged position with respect to a lower threaded support. In a first or fully engaged position, a sealing surface of upper main body is in its lowest position or closest position relative to a lower threaded support. In this position, an uppermost thread on a second threaded body is engaged with an uppermost thread on a first threaded body. In this position, at least a lowermost thread on the second threaded body preferably extends below and is not engaged with a lower most thread on the first threaded body.

In other embodiments, an upper main seal is selectively installed in a third position or fully extended position with respect to a lower threaded support. In a third or fully extended position, a sealing surface of upper main body is in its highest position or farthest position relative to a lower threaded support. In this position, only as many threads on a second threaded body are engaged with threads on a first threaded body as necessary to stably support upper main body in the fully extended position. Most preferably, at least a lowermost thread on the second threaded body is engaged with an upper most thread on the first threaded body in this position.

In still other preferred embodiments, an upper main seal is selectively installed in a second position or intermediate position with respect to a lower threaded support. In a second or intermediate position, a sealing surface of upper main body is disposed somewhere between a first position and a third position.

Such height or spacing adjustment between fully engaged and fully extended positions is preferably achieved only through a threaded connection between an upper main seal and a lower threaded support. In some embodiments, no insertable or stackable components, such as wax or foam rings, are necessary to create a fluid-tight seal and such components are preferably excluded.

A seal according to preferred embodiments herein provides an effective seal between two components in fluid communication with each other while providing adjustability and flexibility in accommodating different heights or spacing between the two components, such as a sink and drainpipe or toilet and closet collar/drainpipe, not requiring the use of a wax seal, and providing consistent sealing ability for positive and negative pressure situations (such as may be encountered when plunging a clogged toilet) over its full range of height/spacing adjustability, and is less prone to failure issues common with prior art seals.

### DETAILED DESCRIPTION OF PREFERRED EMBODIMENTS

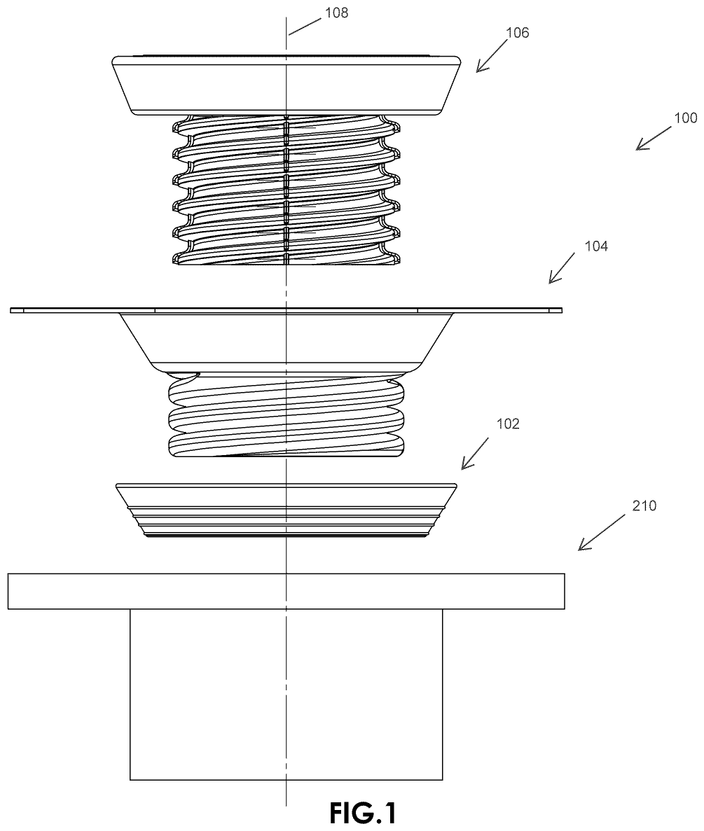

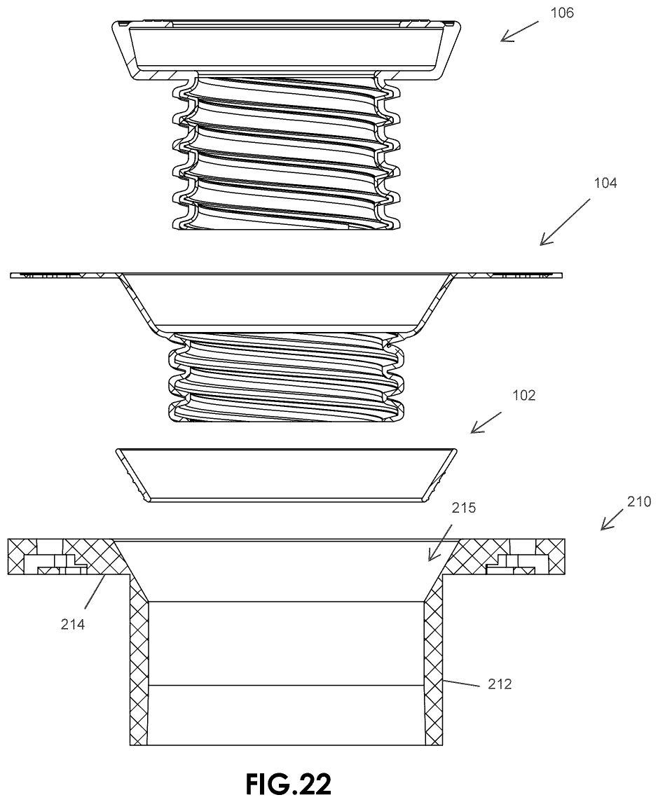

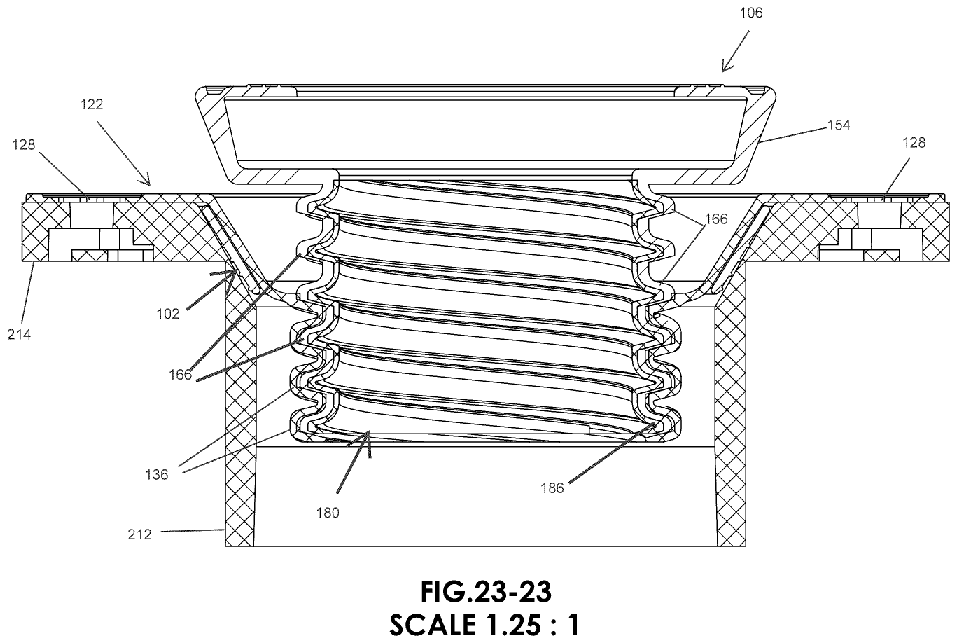

Referring now to FIGS. 1 and 21-26B, a seal assembly 100 according to a preferred embodiment of the invention is shown. Seal assembly 100 preferably comprises a lower seal 102, a lower threaded support 104, and top seal or an upper main seal 106, which may all be axially aligned along a central axis 108. Seal assembly 100 may generally be suitable for forming a fluid tight connection or seal between two components in fluid communication with each other. Although described herein with respect to use with a toilet and a closet collar 210 (connected to a drainpipe 222), seal assembly 100 or various components of seal assembly 100 may also be used with other components requiring a seal to aid in preventing leaks of various fluids (gas or liquid) between components, such as a sink and drainpipe, bathtub or shower and drain pipe, or gas (natural gas) components. Additionally, seal assembly 100 is shown and described herein with a typical, representative closet collar; however, those skilled in the art will recognize that seal assembly 100 disclosed herein may be used with any standard closet collar known in the industry.

### Lower Seal

FIGS. 2-5 show a lower seal 102 according to a preferred embodiment. Lower seal 102 may generally comprise an annular, frustoconical body having a lower end 112 and an upper end 114 and a central aperture 115. A central aperture 115 is disposed through lower seal 102 to allow insertion of lower threaded support 104 through lower seal 102 to create a path for fluid communication between the toilet (not shown) and a closet collar 210 as further described herein. Lower end 112 preferably has a smaller diameter than upper end 114. Lower seal 102 may comprise an inner sealing surface 116 configured to receive and form a fluid tight connection or seal with a lower threaded support 104. Lower seal 102 may also comprise an outer sealing surface 118 configured to form a fluid tight connection or seal with a closet collar 210 when received by closet collar 210. In some embodiments, lower seal 102 may comprise one or more sealing ribs 120 that extend outwardly, and preferably orthogonally, from outer sealing surface 118 and annularly about outer sealing surface 118. In some embodiments, sealing rib 120 may comprise a hemispherical or otherwise rounded, cross-sectional profile. In some embodiments, a sealing rib 120 may enhance the fluid tight connection or seal that lower seal 102 forms with the closet collar 210.

Lower seal 102 may comprise a single unitary component, which may be formed by additive manufacturing, injection molding, or any other suitable process. To form a fluid tight connection or seal between lower threaded support 104 and the closet collar 210, the lower seal 102 may be formed from a thermoplastic vulcanizate (e.g., Santoprene® TPV). The lower seal 102 may also be sized appropriately. For example, in some embodiments, lower end 112 may be about 2.5 to 4.0 inches in diameter, more preferably 3.0 to 3.75 inches in diameter, and most preferably around 3.44 inches (87.37 mm) in diameter. In some embodiments, upper end 114 may be about 3.75 to 4.5 inches in diameter, more preferably 4.0 to 4.2 inches in diameter, and most preferably around 4.33 inches (109.98 mm) in diameter. In some embodiments, lower seal 102 has a thickness between the inner sealing surface 116 and the outer sealing surface 118 (in an area without a sealing rib 120) of about 0.03 to 0.32 inches, more preferably 0.05 to 0.16 inches, and most preferably around 0.06 inches (1.52 mm). Further, in some embodiments, the sealing ribs 120 may have a radius of about 0 to 0.13 inches, more preferably 0.01 to 0.10 inches, and most preferably around 0.015 inches (0.381 mm).

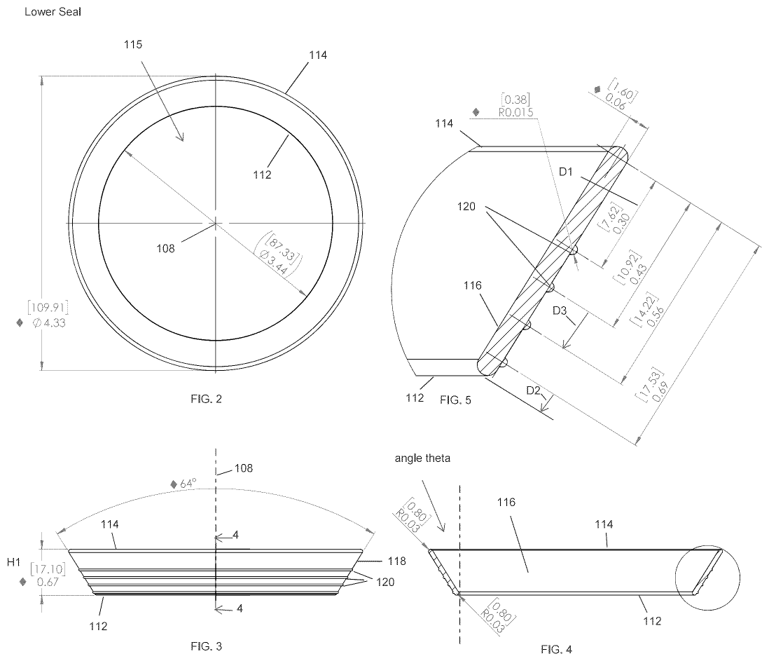

Preferably, lower seal 102 has at least two sealing ribs 120 and most preferably between two and six sealing ribs 120 spaced out along outer sealing surface 118. Sealing ribs 120 may also be spaced out along inner sealing surface 116 in addition to or as an alternative to outer sealing surface 118. A distance D3 between a sealing rib 120 and an adjacent sealing rib 120 is preferably around about 0.10 to 0.50 inches, more preferably 0.12 to 0.25 inches, and most preferably around 0.13 inches (3.3 mm). A distance D1 between upper end 114 and an upper most sealing rib 120 is preferably substantially greater than a distance D2 between lower end 112 and a lower most sealing rib 120. Preferably, D1 about 0.12 to 0.70 inches, more preferably 0.25 to 0.50 inches, and most preferably around 0.30 inches (7.62 mm). Preferably, D2 about 0.00 to 0.40 inches, more preferably 0.03 to 0.20 inches, and most preferably around 0.061 inches (1.55 mm). Opposing sidewalls of inner sealing surface 116 are preferably disposed to form an angle (as shown in FIG. 3) of around 56 to 67 degrees, more preferably 60 to 65 degrees, and most preferably around 64 degrees. Relative to an axis parallel to central axis 108, an angle theta (as shown on FIG. 4) of a sidewall of inner sealing surface 116 is preferably disposed at an angle of around 28 to 33.5 degrees, more preferably around 30 to 32.5 degrees, and most preferably around 32 degrees. A vertical height H1 between upper end 114 and lower end 112 is preferably about 0.5 to 1.25 inches, more preferably 0.6 to 0.8 inches, and most preferably around 0.67 inches (17.10 mm).

According to other preferred embodiments, lower seal 102 (1) may be omitted or (2) may be integrally formed with lower threaded support 104 rather than a separate component.

### Lower Threaded Support

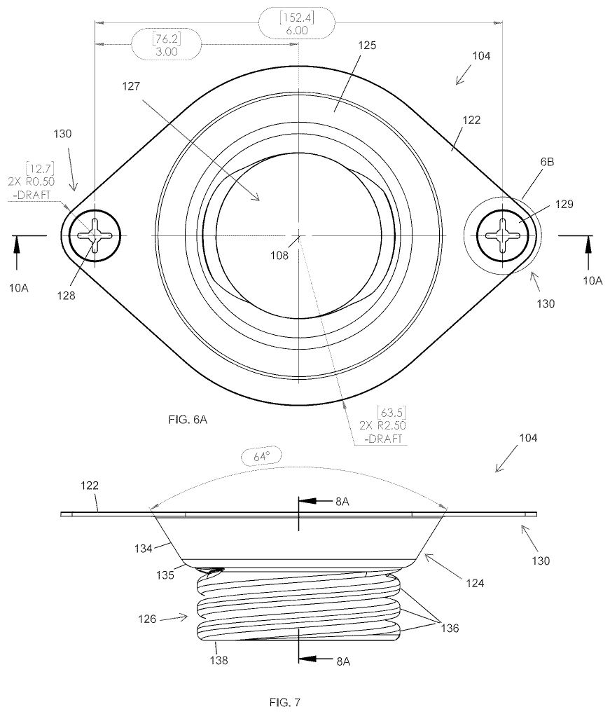

FIGS. 6-10B show a lower threaded support 104 according to a preferred embodiment. Lower threaded support 104 may generally comprise a flange 122, a central body 124 extending inwardly and downwardly from flange 122, and a threaded lower body 126 extending downwardly from central body 124, and an aperture 127. Aperture 127 is disposed through 104 to allow insertion of a portion of upper main seal 106 through lower threaded support 104 to create a path for fluid communication between the toilet (not shown) and closet collar 210 as further described herein. Central body 124 extends from upper end 137 near flange 122 to its lower end or lower shoulder 135 near threaded lower body 126. Lower end 135 preferably has a smaller diameter than upper end 137, such that central body 124 preferably has a frustoconical shape that is generally configured to mate with lower seal 102. Lower threaded support 104 may be configured to bias lower seal 102 against closet collar 210 to form a fluid tight connection or seal with closet collar 210.

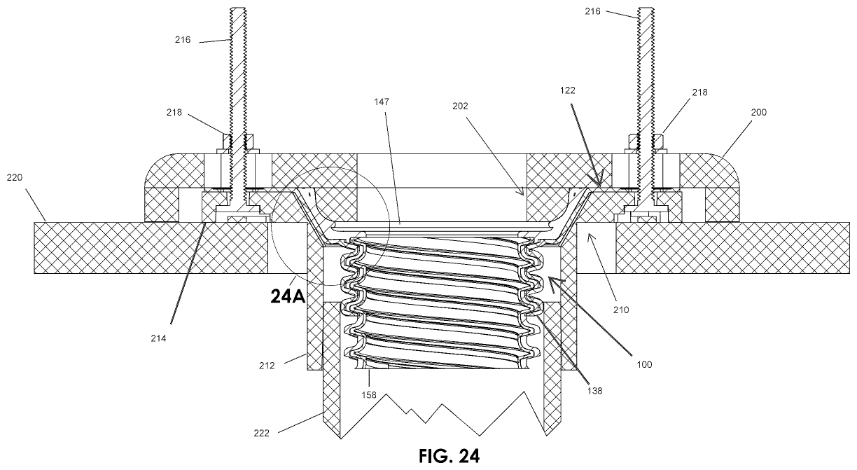

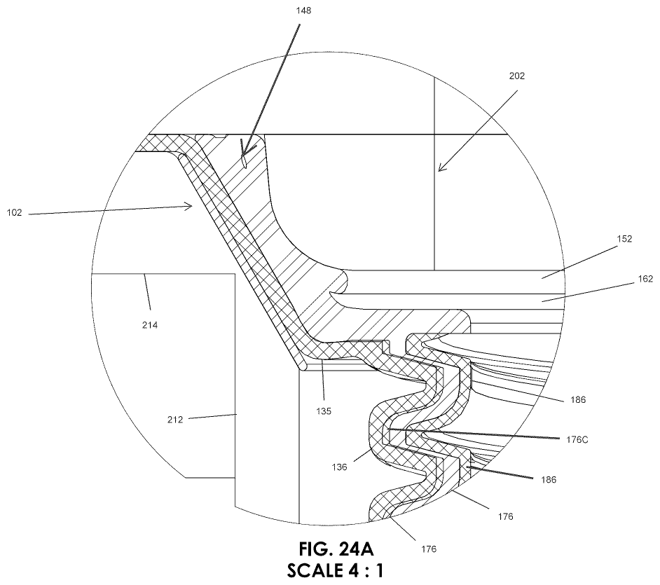

Flange 122 may be substantially planar and preferably comprises elongated ends 130 with a substantially circular area disposed between elongated ends 130. Central body 124 extends downwardly from the substantially circular area. Flange 122 may extend radially in two opposing directions relative to central axis 108, a first direction extending between elongated ends 130 and a second direction being substantially perpendicular to the first direction. Preferably a length of flange 122 in the first direction is longer than a width of flange in the second direction, giving flange 122 a rounded diamond shape when viewed from the top (as shown in in FIG. 6A). A mounting hole 128 is preferably disposed at each elongated end 130 and configured to align with corresponding mounting holes on closet collar 210 to connect lower threaded support 104 to closet collar 210. Mounting holes 128 preferably extend through the flange 122 and align with mounting holes in closet collar 210 to allow lower threaded support 104 to be fastened to closet collar 210 using standard toilet mounting hardware (e.g., closet T-bolts 216, washers, and nuts 218 in FIGS. 24-26). Accordingly, in some embodiments, mounting holes 128 may be spaced most preferably around 6.00 inches (152.4 mm) longitudinally apart to coincide with dimensions on a typical closet collar 210. Further, in some embodiments, a lower surface 132 of flange 122 may be configured to substantially abut portions of the closet collar 210 when fastened to the closet collar 210.

Lower threaded support 104 preferably also comprises washers 129 configured to hold bolts 216 in an upright position during installation of a toilet. One drawback of wax seals and other prior art sealing devices is that there is no structure to maintain bolts 216 extending upwardly from closet collar 210 in an upright position during installation, which can result in bolts 216 tilting during installation so they do not align with apertures in toilet base 200, making installation of the toilet difficult. Washers 129 are preferably integrated into elongated ends 130 of lower threaded support 104, as best shown in FIGS. 6A, 6B, and 10B. Elongated ends 130 preferably comprise a recessed area configured to receive washers 129 such that an upper surface of washers 129 is flush or substantially flush with an upper surface of flange 122. Alternatively, washers 129 may be separate components that are placed over bolts 216 onto elongated ends 130 after lower threaded support 104 is in position in closet collar 210. Washers 129 each preferably comprise a star, a plus sign, or a peace sign shaped aperture forming flaps 131 between the extending prongs of the aperture. A center of an aperture in washer 129 is configured to align with a center of mounting holes 128 and configured to receive a bolt 216 to aid in maintaining bolt 216 in an upright position during installation of the toilet. Washers 129 are preferably made of flexible material, such as polypropylene or other rigid polymeric material, but other materials may also be used. A flexible material is preferred so that when washers 129 are inserted over bolts 216, with bolts 216 extending through mounting holes 128 and washers 129, flap portions 131 of each washer 129 deflect upwardly along its respective bolt 216 to provide upright stability to the bolt 216. The preferred integrated configuration of washers 129 eliminates the need to use separate star washers and corresponding installation steps.

Central body 124 may generally extend inwardly and downwardly from flange 122 and may be enveloped radially by flange 122. In some embodiments, central body 124 comprises a substantially frustoconical shape with a tapered sidewall that is substantially complementary to the frustoconical profile or shape of lower seal 102, such that lower threaded support 104 is configured to fit within lower seal 102 with central body 124 substantially seated on inner sealing surface 116. In some embodiments, central body 124 may be substantially complementary to a tapered portion 215 formed in the closet collar 210, such that lower threaded support 104 is configured to fit within closet collar 210 with central body 124 substantially seated on inner surface of closet collar 210 without using lower seal 102.

Opposing sidewalls of central body 124 are preferably disposed to form an angle (as shown in FIG. 8A) of around 56 to 67 degrees, more preferably 60 to 65 degrees, and most preferably around 64 degrees. Relative to an axis parallel to central axis 108, an angle omega (as shown on FIG. 10A) of a sidewall of central body 124 is preferably disposed at an angle of around 28 to 33.5 degrees, more preferably around 30 to 32.5 degrees, and most preferably around 32 degrees. Most preferably, an angle omega of a sidewall of central body 124 is the same or substantially the same as an angle theta of inner sealing surface 116 relative to central axis 108. Central body 124 is preferably configured and sized to fit within the lower seal 102, such that an outer surface 134 of central body 124 may substantially abut inner sealing surface 116 of lower seal 102. Central body 124 may be sized and/or configured to bias the lower seal 102 against a tapered portion 215 of a closet collar 210 to form a fluid tight connection or seal between lower threaded support 104 and closet collar 210. Most preferably, an upper end 137 of central body 124 (near flange 122) is about 3.69 to 4.44 inches, more preferably 3.94 to 4.14 inches, and most preferably around 4.23 inches (107.33 mm) in diameter and is slightly smaller in diameter than upper end 114 of lower seal 102. Most preferably, a lower end 135 of central body 124 (near threaded lower body 126) is about 2.44 to 3.94 inches, more preferably 2.94 to 3.69 inches, and most preferably around 3.38 inches (85.85 mm) in diameter and slightly smaller in diameter than lower end 112 of lower seal 102.

A vertical height H2 between an upper surface of flange 122 and a lower end 135 of central body 124 is preferably about 0.63 to 1.25 inches, more preferably 0.70 to 1.00 inches, and most preferably around 0.76 inches (19.20 mm). A vertical height or thickness H5 of flange 122 is preferably around 0.01 to 0.08 inches, more preferably around 0.02 to 0.06 inches, and most preferably around 0.04 inches.

A threaded lower body 126 may generally extend downwardly from central body 124. Threaded lower body 126 preferably has a generally cylindrical body comprising consecutive threads 136 that extend from central body 124 to a distal end 138 of threaded lower body 126 (which is preferably also a lowest end of threaded support 104). When viewed in cross-section (such as in FIG. 10A), there are preferably around two to six threads 136 (counting crests), more preferably around three to five threads 136, and most preferably three to four threads 136. In some preferred embodiments, a number of threads 136 is less than a number of threads 166. In some embodiments, threads 136 may be substantially complementary to threads or portions of threads on an upper main seal 106, such that upper main seal 106 may thread into lower threaded support 104 to adjust an overall height of seal assembly 100. Threads 136 may comprise a specially designed thread pitch and shape. Threads 136 are preferably of a dual thread start (or double thread) configuration having a pitch of around 0.33333 to 1.33334, more preferably around 0.88889 to 0.44445, and most preferably around 0.66667 inches. A dual thread start configuration generally has a lead (distance travelled with one complete rotation) that is twice the pitch.

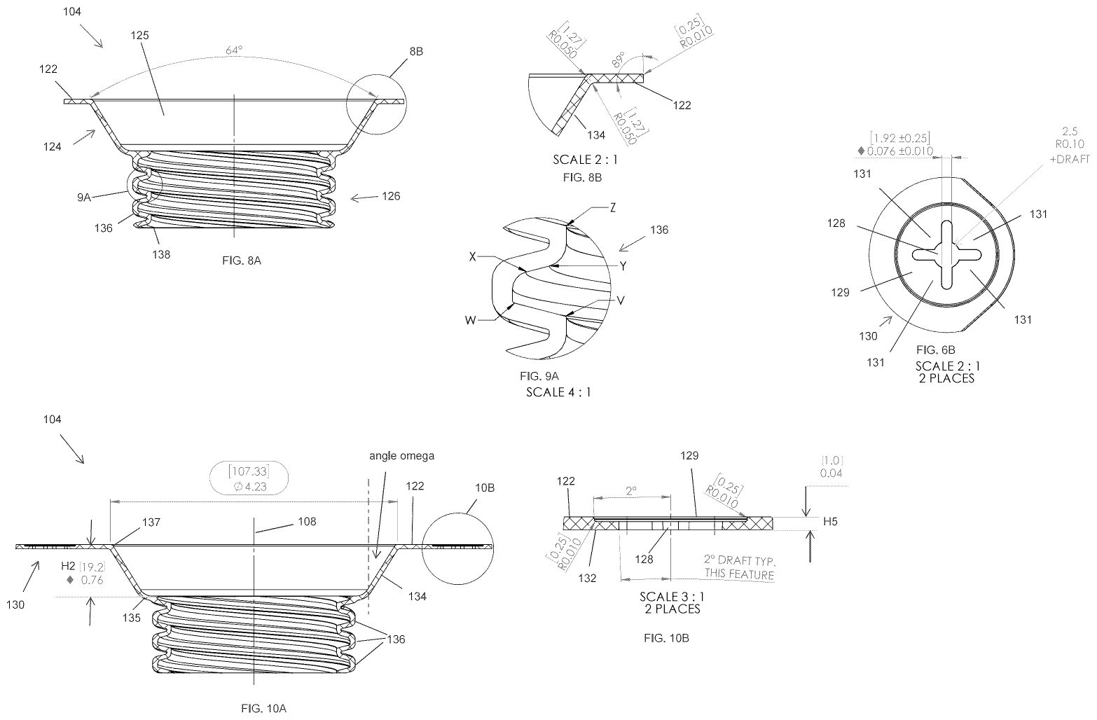

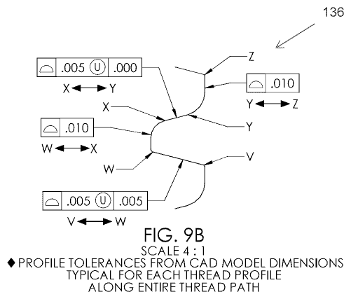

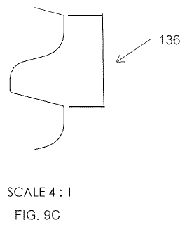

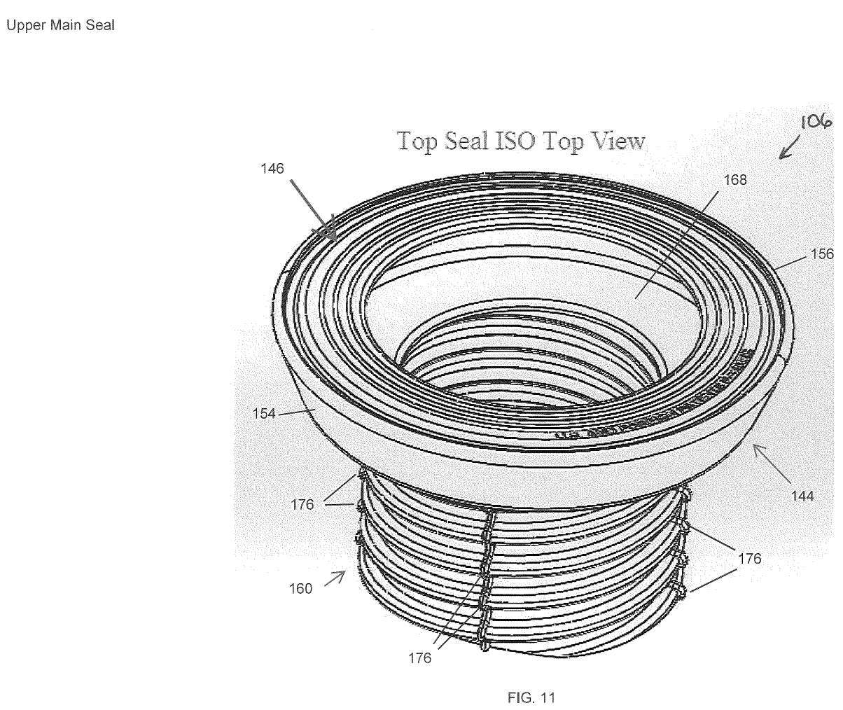

Use of a dual thread start for threads 136 reduces the amount of rotation required to initially engage threads of the mating parts and is faster to adjust axially (relative height or up and down movement of upper main seal 106 to lower threaded support 104) after that. A dual thread start configuration moves twice as far axially as a single thread start for each equivalent degree of rotation. A dual thread start also allows for at least two sweep seals 176 to enter opposing female threads simultaneously ensuring a gas-tight and fluid-tight seal with fewer turns of upper main seal 106. Referring to FIGS. 9A-9C, in some embodiments, each thread 136 may comprise a series of zones or segments as shown between points Z, Y, X, W, and V. A full thread 136 preferably extends from point Z to point V, wherein point V would be equivalent to point Z for the next lower thread 136. Each zone or segment preferably has a bilateral or unilateral profile tolerance as indicated in FIG. 9B. For example, a tolerance between points X and Y is unilateral at 0.005 inches, meaning the profile in that zone preferably will only vary in one direction (less material in this case) from the nominal CAD model of a preferred embodiment shown in FIG. 9B by an amount up to 0.005 inches. The profile tolerances between these segments are preferably not equal in order to maintain an ideal seal compression of around 25 to 45%, more preferably around 35%, of an original size for sweep seals 176 (discussed below). Because a size of each sweep seal 176 preferably varies along its profile, total allowable variation (tolerance) must be distributed unevenly along a profile of each thread 136 as a mating component for sweep seals 176 based on a number of factors including part material, geometry, and manufacturing methods, as will be understood by those of ordinary skill in the art.

Lower threaded support 104 may comprise a single unitary component, which may be formed by additive manufacturing, injection molding, or any other suitable process. In some embodiments, lower threaded support 104 may be formed from a thermoplastic material, such as polypropylene, or any other suitable, preferably substantially rigid polymeric material. However, in some embodiments, the lower threaded support 104 may be formed from aluminum or any other corrosion-resistant material. Additionally, mounting holes 128 may be formed of aluminum or other metal to provide added strength to receive mounting hardware, such as bolts 216.

### Upper Main Seal

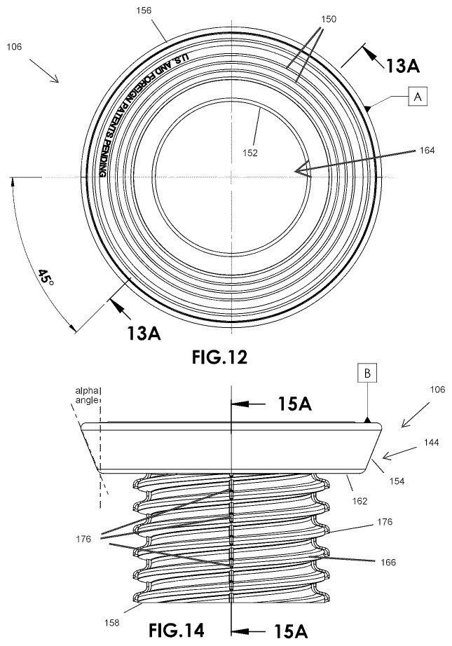

FIGS. 11-17 show an upper main seal 106 according to a preferred embodiment. Upper main seal 106 may generally comprise a main threaded body 160, an upper body 144 extending upwardly and outwardly from main threaded body 160, an upper body 144 extending upwardly and radially outwardly from main threaded body 160, and an aperture 164. Optionally, but preferably, upper main seal 106 also comprises an insert 180. An aperture 164 is disposed through upper main seal 106 to allow a fluid communication path between a horn of a toilet and closet collar 210. Upper main seal 106 may be configured to bias lower threaded support 104 (and consequently lower seal 102, if used) against closet collar 210 to form a fluid tight connection or seal with closet collar 210.

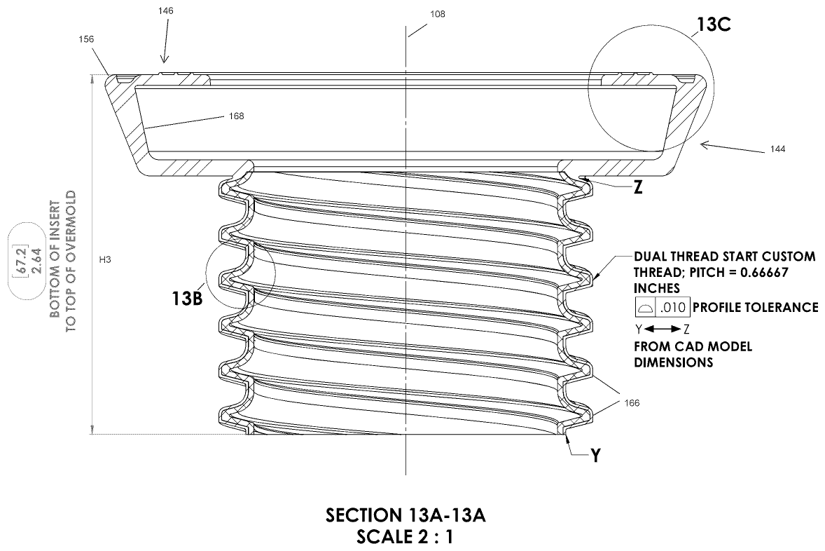

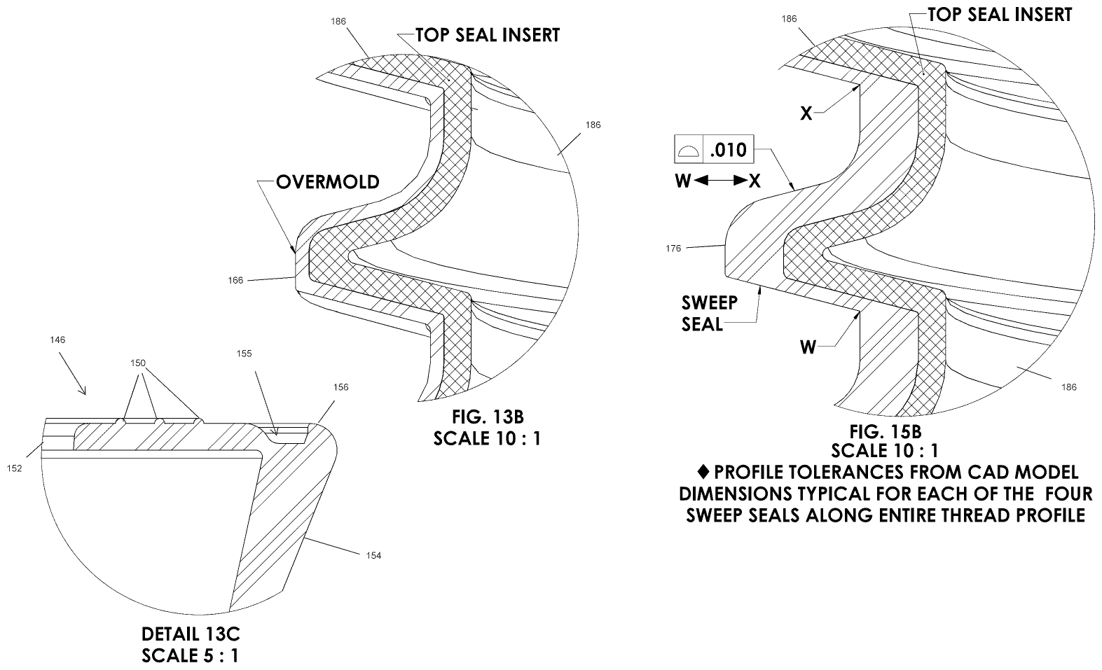

Upper body 144 preferably comprises an annular base 162 extending outwardly from main threaded body 160, a substantially frustoconical body having an outer surface 154 and an interior surface 168 extending upwardly from lower shoulder 157 of annular base 162 to an upper edge 156, a sealing surface 146 extending inwardly from upper edge 156 to an inner edge 152. In some embodiments, a recessed area 155 may be disposed between upper edge 156 and sealing surface 146, as best seen in FIG. 13C. Recessed area 155 provides a thinner area of material to aid in sealing surface 146 to bend downwardly when engaged with toilet horn 202.

Sealing surface 146 preferably comprises an annular flange extending inwardly from an inner edge or shoulder of recessed area 155 or from upper edge 156. In some embodiments, sealing surface 146 may extend slightly downwardly relative to upper edge 156. In other embodiments, sealing surface 146 may substantially flat (or horizontal when not being compressed downwardly by a toilet horn 202) and disposed in a plane substantially perpendicular to central axis 108 that is substantially even or aligned with upper edge 156, as best shown in FIG. 13C. Most preferably, sealing surface 146 comprises one or more sealing ridges 150 on its upper surface. A sealing ridge 150 may be disposed annularly about an upper surface of sealing surface 146. In some embodiments, sealing ridge 150 may comprise a hemispherical or otherwise rounded, cross-sectional profile. In some embodiments, a sealing ridge 150 may enhance the fluid tight connection or seal that upper main seal 106 forms with a toilet horn 202. A sealing ridge 150 may be the same as or similar to sealing rib 120. Alternatively, sealing surface 146 may comprise a series of connected annular steps, each having a substantially flat (or horizontal) upper surface and a radiused or substantially vertical riser connecting to the next lower annular step. In this alternative embodiment, a ridge 150 may be disposed at a joint between a flat and a riser surface of each step. These configurations each provide added flexibility for sealing surface 146 to receive a toilet horn 202, allowing the horn to seat against sealing surface 146 forming a fluid tight connection or seal, with sealing surface 146 being pressed inwardly and downwardly from the positions shown in FIGS. 11 and 13C when toilet horn 202 is seated as discussed further below and shown in FIGS. 24-26B.

Upper body 144 may generally extend inwardly and downwardly from upper edge 156 to lower shoulder 157. In some embodiments, upper body 144 may be substantially complementary to the frustoconical profile of central body 124.

Opposing sidewalls of upper body 144 are preferably disposed to form an angle (similar to that shown in FIG. 3 for lower seal 102 and FIGS. 7-8A for lower threaded support 104) of around 56 to 67 degrees, more preferably 60 to 65 degrees, and most preferably around 64 degrees. Relative to an axis parallel to central axis 108, an angle alpha (as shown on FIG. 14) of a sidewall of upper body 144 is preferably disposed at an angle of around 28 to 33.5 degrees, more preferably around 30 to 32.5 degrees, and most preferably around 32 degrees. Most preferably, an angle alpha of a sidewall of upper body 144 is the same or substantially the same as an angle omega of central body 124 relative to central axis 108. Upper body 144 is preferably configured and sized to fit within central body 124, such that an outer surface 154 of upper body 144 may substantially abut an inner surface 125 of central body 124 in installation configurations where there is contact between outer surface 154 and inner surface 125 (as further discussed below). Upper body 144 may be sized and/or configured to bias lower threaded support 104, and particularly central body 124, against a tapered portion 215 of the closet collar 210 to form a fluid tight connection or seal between lower threaded support 104/lower seal 102 and the closet collar 210. Most preferably, an upper end of upper body 144 (near upper edge 156) is about 3.69 to 4.44 inches, more preferably 3.94 to 4.14 inches, and most preferably around 4.23 inches (107.33 mm) in diameter and slightly smaller in diameter than upper end 137 of central body 124. Preferably, a lower end of upper body 144 (near main lower shoulder 157) is about 2.44 to 3.94 inches, more preferably 2.94 to 3.69 inches, and most preferably around 3.30 inches (83.82 mm) in diameter and slightly smaller in diameter than a lower end 135 of central body 124. A vertical height H3 between upper edge 156 and a lower end 158 of upper main seal 106 is preferably about 2.0 to 3.0 inches, more preferably 2.50 to 2.75 inches, and most preferably around 2.64 inches (67.20 mm).

In other embodiments, upper body 144 may be configured to have a side wall delineated by outer surface 154 that is angled differently from the frustoconical profile of central body 124. In these embodiments, opposing sidewalls of upper body 144 may be disposed to form an angle (similar to that shown in FIG. 3 for lower seal 102 and FIGS. 7-8A for lower threaded support 104) of around 50 to 35 degrees, more preferably 47 to 40 degrees, and most preferably around 44 degrees, while a sidewall of central body 124 is angled at an angle of 56 to 67 degrees. Relative to an axis parallel to central axis 108, an angle alpha (as shown on FIG. 14) of a sidewall of upper body 144 in these embodiments is preferably around 25 to 17.5 degrees, more preferably 23.5 to 20 degrees, and most preferably around 22 degrees, while an angle omega of central body 124 is around 28 to 33.5 degrees. Upper body 144 is still preferably configured and sized to fit within central body 124, deforming as needed based on differences in sidewall angles, such that at least a portion of an outer surface 154 of upper body 144 may substantially abut at least a portion of an inner surface 125 of central body in installation configurations where there is contact between outer surface 154 and inner surface 125 (as further discussed below). Upper body 144 may be sized and/or configured to bias lower threaded support 104, and particularly central body 124, against tapered portion 215 of the closet collar 210 to form a fluid tight connection or seal between lower threaded support 104 and the closet collar 210. Most preferably, an upper end of upper body 144 (near upper edge 156) is about 3.5 to 4.65 inches, more preferably 3.75 to 4.5 inches, and most preferably around 4.41 inches (112.01 mm) in diameter and slightly smaller in diameter than upper end 137 of central body 124. Preferably, a lower end of upper body 144 (near lower shoulder 157) is about 2.5 to 4.2 inches, more preferably 2.75 to 4.0 inches, and most preferably around 3.90 inches (99.06 mm) smaller in diameter than a lower end of central body 124. A vertical height H3 between upper edge 156 and a lower end 158 of upper main seal 106 is preferably about 2.0 to 3.0 inches, more preferably 2.50 to 2.75 inches, and most preferably around 2.64 inches (67.20 mm), which is preferably the same height as when the a side wall delineated by outer surface 154 is angled similarly to the frustoconical profile of central body 124.

A main threaded body 160 may generally extend downwardly from upper body 144 and most preferably from annular base 162. Main threaded body 160 preferably has a generally cylindrical shape comprising consecutive threads 166 that extend from an annular base 162 of upper body 144 to a distal end 158 of main threaded body 160 (which is preferably also a lowest end of upper main seal 106). When viewed from a front elevation (such as in FIG. 14), there are preferably around four to ten threads 166 (counting crests), more preferably around five to eight threads 166, and most preferably six threads 166. In some preferred embodiments, a number of threads 166 is more than a number of threads 136. In some embodiments, the threads 166 may be substantially complementary to threads 136 or portions of threads 136 on lower threaded support 104, such that upper main seal 106 may thread into lower threaded support 104 to adjust an overall height of seal assembly 100 relative to components being connected with seal assembly 100 and/or a structure around such components (e.g., a floor surface 220 on which a toilet base 200 will rest). Threads 166 are preferably configured to handle high axial loads without failure. Threads 166 may comprise a specially designed thread pitch and shape. Preferably, threads 166 are configured to engage with threads 136 on lower threaded support 104. Like threads 136, threads 166 are preferably of a dual thread start (or double thread) configuration having a pitch of around 0.33333 to 1.33334, more preferably around 0.88889 to 0.44445, and most preferably around 0.66667 inches. Most preferably threads 166 run completely up to annular base 162 of upper body 144 to allow main threaded body 160 to be completely threaded into threaded lower body 126 of lower threaded support 104 for maximum height adjustability of upper main seal 106 relative to lower threaded support 104.

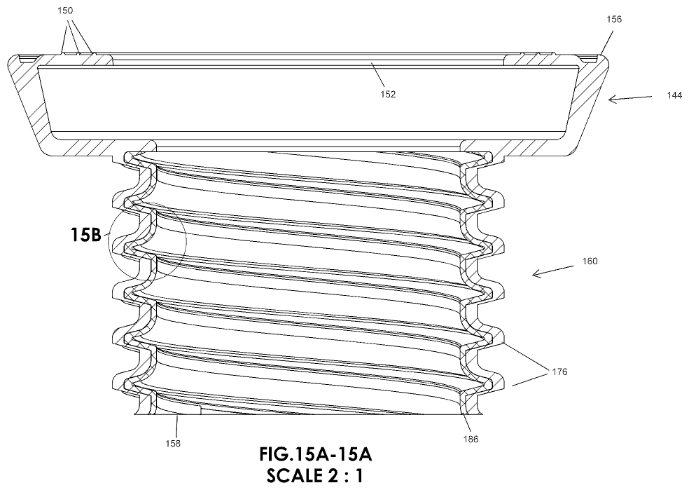

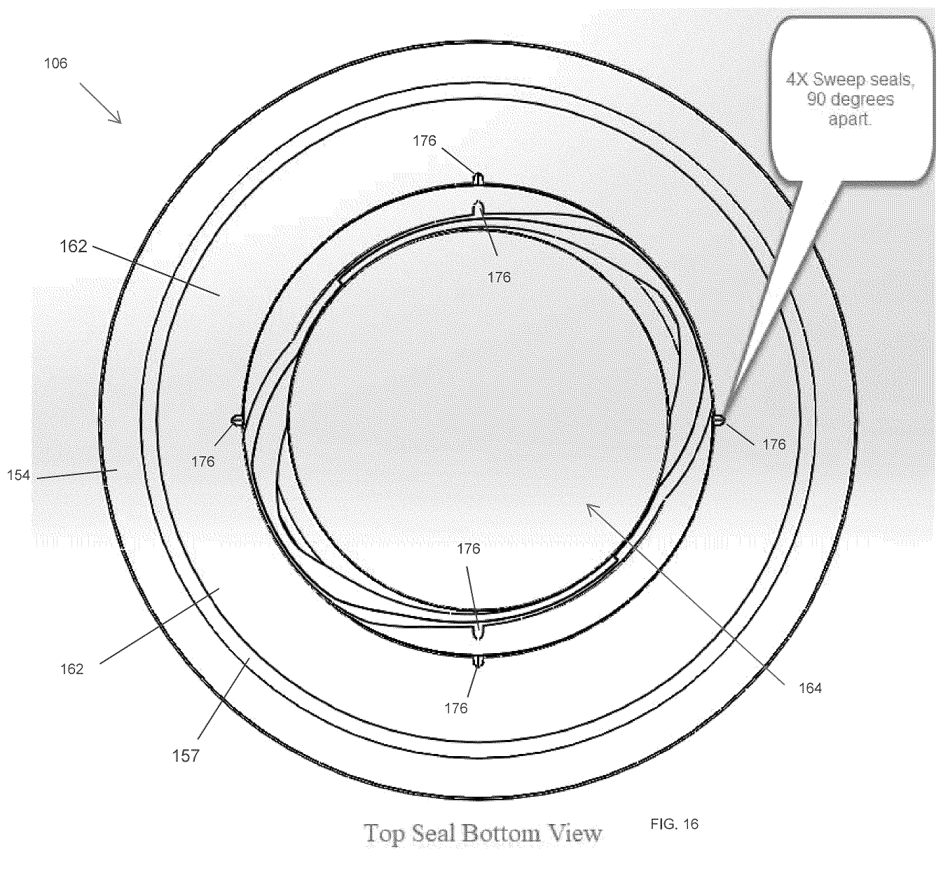

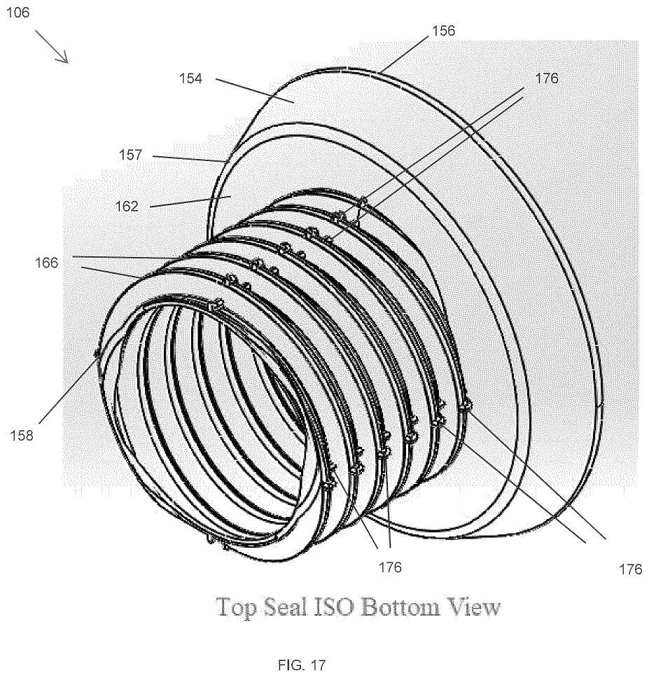

In addition to threads 166, main threaded body 160 preferably comprises a thread chaser seal or sweep seal 176 extending outwardly from an outer surface of main threaded body 160, as best shown in FIGS. 11, 15B, 16, and 17. For additional reference, FIG. 15B shows a cross-sectional view taken through an area with sweep seals 176, whereas FIG. 13B shows a cross-sectional view taken through an area without sweep seals 176. Preferably, sweep seals 176 are oriented and aligned substantially vertically along an exterior surface of main threaded body 160. Most preferably, there are three to four sets of sweep seals 176 spaced apart from each other vertically and circumferentially at a sweep seal location, preferably each sweep seal location being substantially equidistant around an outer circumference of main threaded body 160. Four sets of sweep seals 176 are shown in FIG. 16, with each circumferential sweep seal location spaced around 90° from an adjacent circumferential sweep seal location. Alternatively, three sets of sweep seals 176 may be used with each circumferential sweep seal location spaced around 120° from an adjacent circumferential sweep seal location. Although other spacing and different numbers of sets of sweep seals 176 may be used, four sets spaced at 90° is most preferred. More than four sets of sweep seals 176 may make mold separation in manufacturing upper main seal 106 more difficult. Two sets of sweep seals 176 provide less sealing opportunities and would not apply equal forces to center upper main seal 106 in lower threaded support 104 and may possibly allowing upper main seal 106 to move too much in a direction 90 degrees opposed to a location of sweep seals 176. Three sets of sweep seals 176 accomplish equal forces for centering upper main seal 106 in lower threaded support 104, but may make mold separation difficult. Four sets of sweep seals 176 provide equal forces for centering, helps keep mating parts axially aligned better which in turn helps improve sealing by reducing wobble between them, and does not present mold separation issues.

Preferably, there are a plurality of shorter sweep seals 176 spaced apart from each other vertically (as best seen in FIG. 17, where sweep seals 176 are not placed on a bottom surface of threads 166). Sweep seals 176 are also preferably spaced from each other at substantially equidistant vertical locations, such as an exterior crest of one or more threads 166. Most preferably, there is a sweep seal 176 on a crest of each thread 166 in a sweep seal location. Alternatively, each sweep seal 176 may comprise a continuous length of material extending outwardly from an exterior of main threaded body 160 and extending longitudinally across two or more crests of threads 166 or extending longitudinally from or substantially near annular base 162 of upper body 144 to or substantially near lower end 158. As an additional alternative, shorter sweep seals 176 may be placed at varying positions along an exterior of main threaded body 160, not necessarily equally aligned vertically and/or circumferentially. As a further alternative, any combination of sweep seal 176 positioning and length may be used.

Sweep seals 176 preferably have a profile that generally corresponds to or conforms to a profile of threads 186 (discussed below), but has thickness variations in its profile that differ from overmolded threads 166. This is seen in a comparison of FIG. 13B (a cross-section of threads 186 and threads 166 without a sweep seal 176) and 15B (a cross-section through a sweep seal 176), where portions of sweep seal 176 in FIG. 15B are thicker (in a direction extending from central axis 108 outwardly) than corresponding portions of overmolded thread 166 in FIG. 13B. A zone or segment between points W to X on sweep seal 176 preferably has a bilateral profile tolerance as indicated in FIG. 15B. One of ordinary skill in the art would understand that as features and size of mating components vary in their tolerance ranges due to materials and manufacturing methods, the respective interfaces of each component move together or apart nonlinearly due to the thread geometry. A profile shape of sweep seal 176 reflects that average variation in relative movement while preferably maintaining consistent compression throughout. Sweep seals 176 aid in achieving optimal compression, avoiding compression set, and creating a fluid tight seal between lower threaded support 104 and upper main seal 106.

Once installed, a toilet is generally fairly static such that compression set would not normally be thought of as an issue. However, there can be movement in an installed toilet that makes reducing compression set beneficial. For example, if the toilet is clogged and needs to be plunged, if there are temperature variations that cause expansion or contraction, or if the toilet is removed and reinstalled using the same seal (such as seal assembly 100), these changing forces applied on the seal could be problematic for the integrity of a seal if the sealing components experience compression set. Thus, avoiding compression set through the preferred use of sweep seals 176 can be advantageous. Additionally, seal assembly 100 can be used for sealing other components in fluid communication with each other and those components may experience more movement than in a toilet installation. Although it is unlikely that water from the toilet would access an area between lower threaded support 104 and upper main seal 106, seal assembly 100 is also designed to aid in preventing sewer gases from leaking into a space around the toilet. The additional sealing function provided by sweep seals 176 aids in preventing gases from leaking through seal assembly 100. Additionally, the preferred use of sweep seals 176 provides these benefits while still allowing upper main seal 106 to easily thread into lower threaded support 104. As an alternative, an entire surface of overmolded main threaded body 160 could be made thicker without the use of sweep seals 176; however, that embodiment may create too much friction between main threaded body 160 and threaded lower body 126 during threading causing them to bind up and may create issues with the profile tolerance stack between the mating components due to materials and manufacturing methods, and as the parts are increasingly threaded together.

The upper main seal 106 may comprise a single unitary component, which may be formed by additive manufacturing, injection molding, or any other suitable process. In some embodiments, the upper main seal 106, and particularly at least upper body 144 and sealing surface 146, may be formed from a thermoplastic vulcanizate (e.g., Santoprene® TPV) or other applicable thermoplastic elastomer.

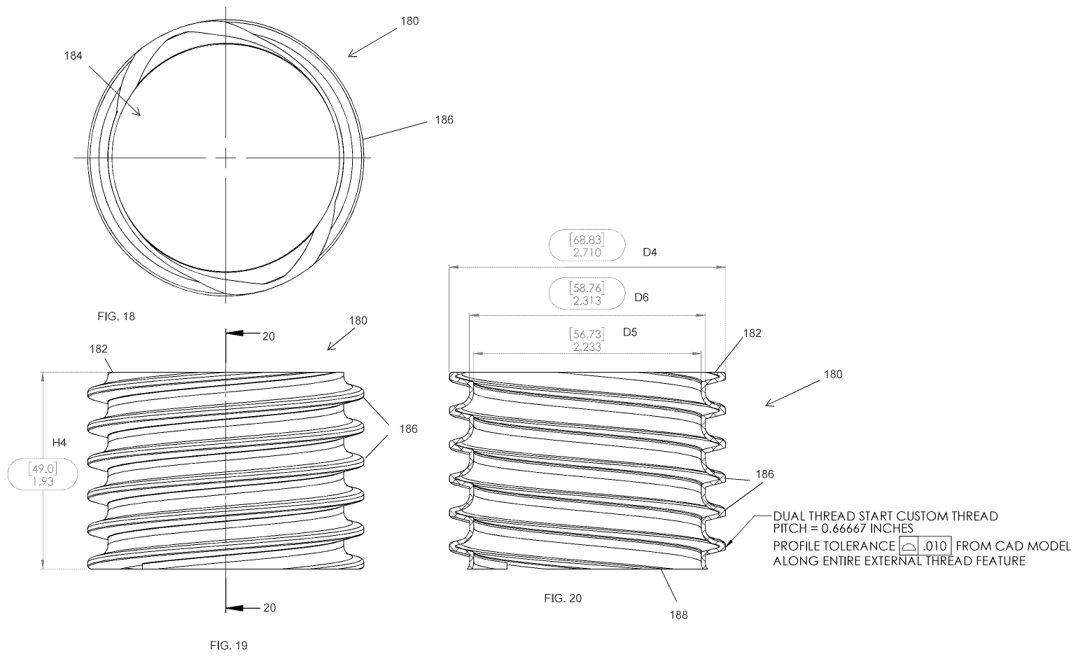

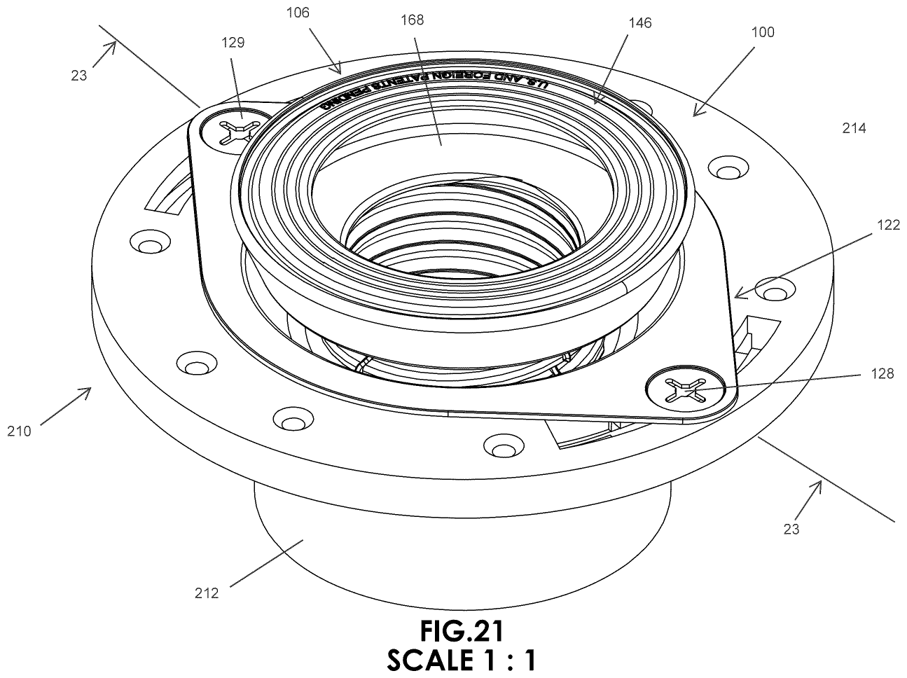

Main threaded body 160 may also comprise an insert 180, as shown in FIGS. 18-20. Insert 180 generally has cylindrical shape comprising consecutive threads 186 that extend from an upper end 182 to a lower end 188. An aperture 184 is disposed through insert 180 to allow a fluid communication path between a toilet horn 202 and closet collar 210 through aperture 184. Aperture 184 is preferably concentric with aperture 164 in upper main seal 106. In some embodiments, an exterior of threads 186 may be substantially complementary to an interior of threads 166 of main threaded body 160. Like threads 166, threads 186 are preferably of a dual thread start (or double thread) configuration having a pitch of around 0.33333 to 1.33334, more preferably around 0.88889 to 0.44445, and most preferably around 0.66667 inches.

Insert 180 is preferably made of substantially rigid material, such as Polycarbonate or Polypropylene, to provide structural support for a threaded connection between lower threaded support 104 and upper main seal 106 that will support upper main seal 106 in a desired and selected position relative to lower threaded support 104 (and relative to closet collar 210) to provide the correct height and placement for seal assembly 100 based on the configuration of the installed closet collar 210. Most preferably, upper main seal 106, or at least main threaded body 160, is overmolded around insert 180 so that an inner surface of threads 166 conforms to an exterior surface of threads 186. Although it is preferred to use insert 180 overmolded by other parts of main threaded body 160 and/or upper main seal 106, alternatively, main threaded body 160 may be made from substantially rigid material, such as TPE, without using an insert 180.

Preferably, an overall outer diameter D4 (across from exterior crests of threads 186) of insert 180 is about 2.6 to 2.9 inches, more preferably 2.65 to 2.8 inches, and most preferably around 2.710 inches (68.83 mm). Preferably, an interior root diameter D5 (across interior surfaces of roots of threads 186) of insert 180 is about 2.0 to 2.4 inches, more preferably 2.13 to 2.3 inches, and most preferably around 2.23 inches (56.73 mm). Preferably, a thickness of insert 180 is about 0.03 to 0.08 inches, more preferably 0.035 to 0.063 inches, and most preferably around 0.04 inches (1.02 mm), which is a difference between D6 and D5. A vertical height H4 between upper end 182 and lower end 188 of insert 180 is preferably about 1.25 to 2.25 inches, more preferably 1.75 to 2.0 inches, and most preferably around 1.93 inches (49.00 mm). This is preferably the same or substantially the same as a vertical height of main threaded body 160.

According to still other preferred embodiments, a seal comprising a threaded exterior may comprise sweep seals 176. Such seal may be used as part of a fluid connection between two components, such as plumbing components (other than toilets) or gas conveying components. Sweep seals 176 used in such other embodiments preferably are configured to conform to an exterior profile or shape of threads on the seal and may also be configured as otherwise described herein.

### Assembled and Installed

FIGS. 21 and 24-26 show a seal assembly 100 as installed in a closet collar 210 and FIGS. 24-26B also show installation relative to a floor height with a toilet in place. These figures show different possible positions (above grade, at grade, and below grade) for closet collar 210 relative to a surface (e.g., a floor) on which a toilet will sit and how seal assembly 100 may be adjusted by raising or lowering upper main seal 106 to accommodate the different positions.

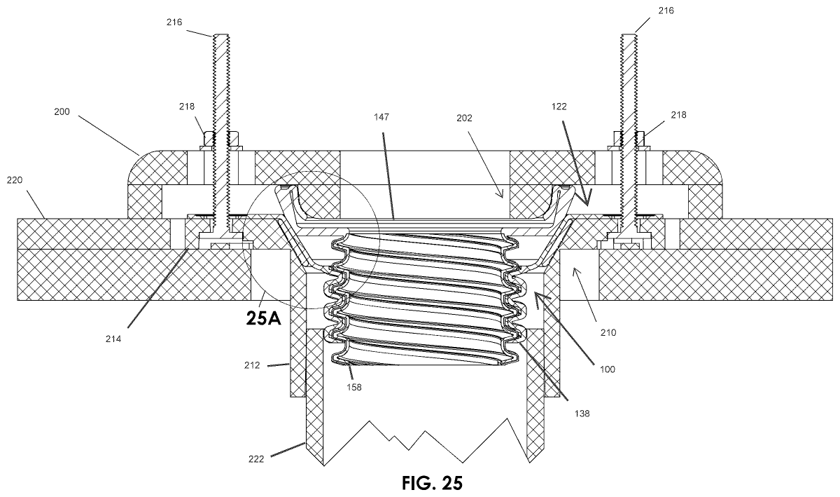

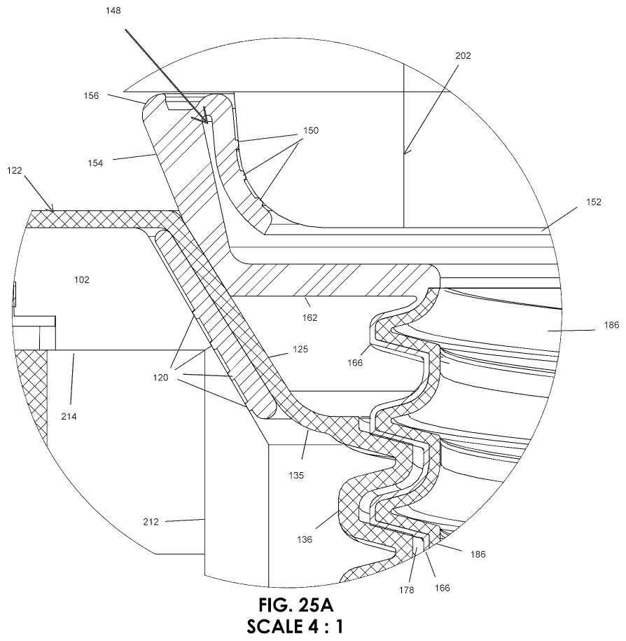

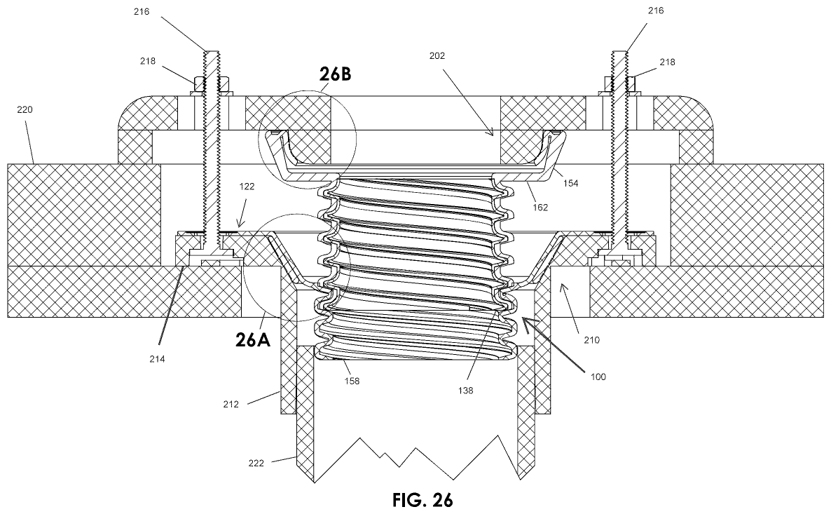

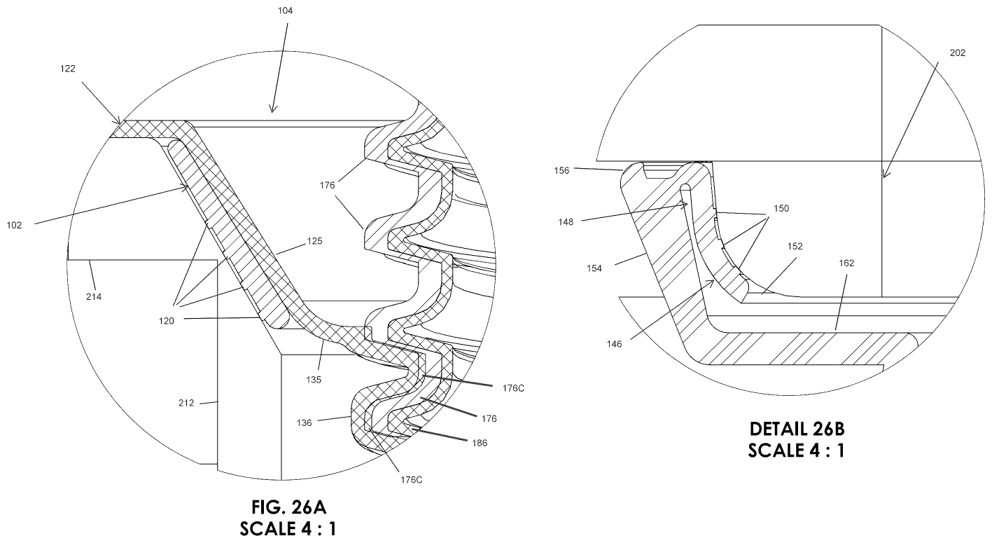

FIG. 24 shows a cross-section side elevation view of seal assembly 100 in an assembled state according to some embodiments and connected to a toilet base 200 and a typical closet collar 210 installed above a floor level 220. FIG. 25 shows a cross-section side elevation view of seal assembly 100 in an assembled state in some embodiments and connected to a toilet base 200 and a typical closet collar 210 installed at a floor level 220. FIG. 26 shows a cross-section side elevation view of a seal assembly 100 in an assembled state in some embodiments and connected to a toilet base 200 and a typical closet collar 210 installed below a floor level 220. These figures show relative positioning of components of seal assembly 100 when closet collar 210 is installed at different heights. Closet collar 210 typically comprises an annular flange 214, a cylindrical body 212 extending downwardly from annular flange 214, and tapered or frustoconical portion 215. Closet collar 210 may be installed such that an upper surface of annular flange 214 is disposed above a floor level 220 (as shown in FIG. 24), or is even or substantially even with a floor level 220 (as shown in FIG. 25), or is disposed below a floor level 220 (as shown in FIG. 26). Cylindrical body 212 may be connected to a drainpipe 222. Toilet base 200 rests at floor level 220 and is typically connected to closet collar 210 with bolts 216 and nuts 218. A toilet horn 202 is inserted into and seated against a portion of upper main seal 106. FIGS. 24A, 25A, and 26A-26B show enlarged portions of FIGS. 24, 25, and 26, respectively, illustrating compression of upper main seal 106 and lower seal 102 for various installation heights of closet collar 210 relative to floor level 220. Although FIGS. 24A, 25A, and 26A are all cross-sectional views, hatch lines have been omitted from the portions of closet collar 210 and toilet horn 202 for ease of viewing components of seal assembly 100.

When toilet horn 202 seats against sealing surface 146, it forces sealing surface 146 to fold downwardly. Depending on the height of closet collar 210, sealing surface 146 may fold completely or almost completely in contact with interior surface 168 of upper body 144, with very little gap 148 (as shown in FIG. 24A), or there may be a larger gap 148 between them (as shown in FIGS. 25A and 26A). For each exemplary height of closet collar 210, lower seal 102 is compressed against an inner surface of tapered portion 215 of closet collar 210 by outer surface 134 of upper body 144. In some installation embodiments, such as in FIG. 24-24A, lower seal 102 may be more compressed than in other installation embodiments, such as in FIGS. 25A, 26A. In installation embodiments like those in FIGS. 25, 26, there may be a small gap between outer sealing surface 118 and an inner surface of tapered portion 215 of closet collar 210 with one or more sealing ribs 120 making contact with an inner surface of tapered portion 215. In installation embodiments like that in FIG. 24, there may be no gap between outer sealing surface 118 and an inner surface of tapered portion 215 with sealing ribs 120 completely compressed.

Additionally, a position of upper main seal 106 relative to lower threaded support 104 will selectively vary depending on a height of closet collar 210 relative to floor level 220. In some embodiments, upper main seal 106 is at a first position (or fully threaded position) relative to lower threaded support 104 in which upper main seal 106 is completely threaded into lower threaded support 104 as far as it can be threaded. In other embodiments, upper main seal 106 is at a third position (or fully extended position) relative to lower threaded support 104 in which upper main seal 106 is threaded into lower threaded support 104 only as much as needed to support upper main seal 106 in its highest elevation position. Most preferably, when in the third position (or fully extended position), at least one full thread 166 is engaged with a thread 136 when viewed in cross-section. In still other embodiments, upper main seal 106 is at one of a plurality of selective second positions (or intermediate position) disposed between the first position and third position.

As can be seen in FIGS. 24-24A, when a closet collar 210 is installed above floor level (such as when a lower surface of annular flange 214 rests on floor level 220), upper main seal 106 may be at, and most preferably is at, the first position relative to lower threaded support 104. Generally, the first position involves full contact between upper portions of lower threaded support 104 and upper main seal 106. In this exemplary installation embodiment, toilet horn 202 compresses upper main seal 106 against central body 124 of lower threaded support 104, which provides further compression of central body 124 against lower seal 102 and lower seal 102 against in interior surface of closet collar 210. Main threaded body 160 is preferably fully threaded into threaded lower body 126 such that lower end 158 of main threaded body 160 extends below distal end 138 of threaded lower body 126 and annular base 162 abuts lower end 135.

In a first position installation embodiment, flange 122 may be sandwiched between (and preferably in direct contact with both) a portion of toilet base 200 and annular flange 214 of closet collar 210. Lower threaded support 104 and lower seal 102 are held in position by toilet horn 202 seating in upper body 144 to provide compressive contact between at least a majority of upper body 144, or an entirety of upper body 144, and at least a majority of central body 124, or an entirety of central body 124 and by engagement between threads 166 on upper main seal 106 and threads 136 on lower threaded support 104. Mounting holes 128, and preferably washers 129, coupled with bolts 216 also keep lower threaded support 104 from rotating during installation and adjustment of a position of upper main seal 106.

As can be seen in FIGS. 25-25A, when closet collar 210 is installed at or around floor level 220, upper main seal 106 may be at, and preferably is at, one of the plurality of second positions relative to lower threaded support 104. In a second position, upper main seal 106 is higher or more elevated than in the first position but lower than the third position. In this exemplary installation embodiment, toilet horn 202 compresses a lower portion of outer surface 154 of upper body 144 on upper main seal 106 against an upper portion of inner surface 125 on central body 124 of lower threaded support 104. This, in turn, provides some compression of central body 124 against lower seal 102 and lower seal 102 against an interior surface of tapered portion 215, but not as much compression of lower seal 102 as in the installation embodiment of FIG. 24.

In some embodiments when in a second position, main threaded body 160 is preferably partially threaded into threaded lower body 126 such that lower end 158 of main threaded body 160 extends below distal end 138 of threaded lower body 126, but some threads 166 on an upper portion of main threaded body 160 do not engage with threads 136 on threaded lower body 126, but are instead disposed in an interior space of central body 124 or possibly even above flange 122. In other embodiments when in a second position, main threaded body 160 is preferably partially threaded into threaded lower body 126 such that lower end 158 of main threaded body 160 does not extend below distal end 138 of threaded lower body 126 and more threads 166 on an upper portion of threaded lower body 126 do not engage with threads 136 on threaded lower body 126, but upper main seal 106 is still below the third position. The number of threads 166 that engage with threads 136 or are disposed above lower end 135 or below distal end 138 will depend on the total number of threads 166 and total number of threads 136 used, coupled with the selected one of the second positions, as will be understood by those of ordinary skill in the art.

In a second position installation embodiment, flange 122 is in contact (and preferably direct contact) with annular flange 214 on closet collar 210 but likely does not contact any portion of toilet base 200. Lower threaded support 104 and lower seal 102 are held in position by toilet horn 202 seating in upper body 144 to provide compressive contact between a portion of upper body 144 and a portion of central body 124 and by engagement between threads 166 on upper main seal 106 and threads 136 on lower threaded support 104. The engagement between threads 166 and threads 136, coupled with rigidity of insert 180, allow an upper portion of upper main seal 106 to be supported when in a second position without making full contact between upper body 144 and central body 124. Mounting holes 128, and preferably washers 129, coupled with bolts 216 also keep lower threaded support 104 from rotating during installation and adjustment of a position of upper main seal 106.

As can be seen in FIGS. 26-26B, when closet collar 210 is installed below floor level 220, upper main seal 106 needs to be elevated to engage with toilet horn 202. As such, upper main seal 106 may be at a third position relative to lower threaded support 104 in some installations where closet collar 210 is installed below floor level 220. Depending on how far below floor level 220 closet collar 210 is installed, upper main seal 106 may also be at a selected second position as previously discussed. The third position is generally the highest position, being more elevated than either the first or any of the second positions. The exact position of upper main seal 106 relative to lower threaded support 104 may also fall anywhere between the first and the second positions or the second and third positions illustrated in these exemplary installation embodiments. In this exemplary installation embodiment, toilet horn 202 contacts at least a portion of upper body 144 to create a seal, but no portion of upper body 144 contacts inner surface 125 on central body 124 of lower threaded support 104. Main threaded body 160 is preferably partially threaded into threaded lower body 126 such that distal end 138 of threaded lower body 126 does not extend below lower end 158 of main threaded body 160 and most threads 166 on an upper portion of main threaded body 160 do not engage with threads 136 on threaded lower body 126. In the third position, preferably at least one full thread 166 is engaged with a thread 136 to adequately support upper main seal 106. In other embodiments, an exterior surface of one or more lower threads 166, such as thread 166A in FIG. 26A, may be marked, such as with a different color. This marking would indicate to a user when the third or fully extended position is reached and that upper main seal 106 should not be further extended upwardly from that point. Most preferably, a marked thread 166A will indicate that the third or fully extended position has been reached when it is visible within central body 124 near lower end 135.

In a third position installation embodiment, flange 122 is in contact (and preferably direct contact) with annular flange 214 on closet collar 210 but does not contact any portion of toilet base 200. Lower threaded support 104 and lower seal 102 are held in position by toilet horn 202 seating in upper body 144 to provide compressive contact only between threads 166 on upper main seal 106 and threads 136 on lower threaded support 104. The engagement between threads 166 and threads 136, coupled with rigidity of insert 180, allow an upper portion of upper main seal 106 to be supported without making any contact between upper body 144 and central body 124. Mounting holes 128, and preferably washers 129, coupled with bolts 216 also keep lower threaded support 104 from rotating during installation and adjustment of a position of upper main seal 106.

The compressive force of the weight of toilet horn 202 acting through engagement of threads 166 and threads 136, with either full contact (FIGS. 24-24A), partial contact (FIGS. 25-25A), or no contact (FIGS. 26-26B) between upper body 144 and central body 124, provides some compression of central body 124 against lower seal 102 and lower seal 102 against an interior surface of a tapered portion 215 of closet collar 210. With full contact between upper body 144 and central body 124, the compression of lower seal 102 is greater than with either partial or no contact.

Depending on where sweep seals 176 are positioned on main threaded body 160, and the position of upper main seal 106 relative to lower threaded support 104, a cross-sectional may be through sweep seals 176 or may only be through overmolded threads 166. With the embodiments depicted in FIGS. 24-24A and FIGS. 26-26A, the cross-sectional view is taken through sweep seals 176 on upper main seal 106. In FIGS. 24A and 26A, a portion 176C of a sweep seal 176 is shown in cross hatching different from cross hatching the remainder of sweep seal 176 to show compression of sweep seal 176 between threads 186 and threads 136. With the embodiment depicted in FIGS. 25-25A, the cross-sectional view is taken through overmolded threads 166 in an area without sweep seals 176. As can be seen in FIG. 25A, there is a small gap 178 between threads 166 and threads 136. This gap 178 aids in allowing main threaded body 160 to easily and smoothly thread into threaded lower body 126.

The configurations and positionings of closet collar 210, toilet base 200, and drainpipe 222 in FIGS. 24-26B are exemplary. Seal assembly 100 may be used with other configurations and positioning as will be understood by those of ordinary skill in the art.

A preferred method of using seal assembly 100 comprises removing or separating the two components (e.g., removing the toilet from the closet collar 210) that are to be connected by seal assembly 100, if not already done, and cleaning the area of any prior sealants, such as a wax ring. Lower seal 102 may be inserted into tapered portion 215 of closet collar 210. Then lower threaded support 104 may be inserted through lower seal 102 into closet collar 210 with threaded lower body 126 disposed in cylindrical body 212. Elongated ends 130 and mounting holes 128 are positioned to align mounting holes 128 with corresponding mounting structure on annular flange 214 of closet collar 210 to allow standard connectors, such as bolts 216, to be inserted through mounting holes 128 to align lower threaded support 104 with closet collar 210. Alternatively, lower seal 102 may be positioned together with lower threaded support 104 prior to inserting them as a unit into closet collar 210. As another alternative, when lower seal 102 and lower threaded support 104 are integrally formed as a single unit, lower threaded support 104 may be inserted into closet collar 210 so that central body 124 engages with tapered portion 215 and threaded lower body 126 is inserted into cylindrical body 212 of closet collar 210.

Then, upper main seal 106 is inserted through central body 124 of lower threaded support 104 and rotated so that threads 166 engage with threads 136. Alternatively, upper main seal 106 and lower threaded support 104 may be positioned together by engaging threads 166 with threads 136 prior to inserting upper main seal 106 and lower threaded support 104 as a unit into lower seal 102 and closet collar 210. As another alternative, all three components—lower seal 102, lower threaded support 104, and upper main seal 106—may be positioned together, with threads 166 engaged with threads 136, as a unit prior to inserting them in closet collar 210. Other variations may also be used as will be understood by those of ordinary skill in the art depending on the configuration of seal assembly 100 as separate components that are put together at the time of use or that are pre-assembled combinations of components (either integrally formed as one single piece or separate components adhered together or separate components pre-assembled together, or any combination thereof). Once the components of seal assembly 100 are in position in closet collar 210, upper main seal 106 may be rotated as needed to raise or lower a position of upper edge 156 relative to an upper surface of closet collar 210 and/or a floor surface 220 (or other applicable surface depending on the components being connected with seal assembly 100) to ensure a good fit and tight seal between the components (e.g., the toilet horn 202 and closet collar 210).

Once at a desired level, a toilet (or other component) may be placed over and engaged with sealing surface 146 on upper main seal 106. Most preferably, the weight and/or placement of the toilet, particularly toilet horn 202, will cause sealing surface 146 to deform downwardly into aperture 164 so that a surface of toilet horn 202 (or surrounding area) is in contact with sealing surface 146. Depending on the size of sealing surface 146, a portion of toilet horn 202 may also be in contact with at least a portion of an interior surface 168 of upper body 144. In some installation embodiments, depending on a position of closet collar 210 relative to floor level 220, this may compress upper body upper body 144 so that at least a portion of outer surface 154 is in contact with at least a portion of inner surface 125 of central body 124. This compression in turn causes at least a portion of outer surface 134 of central body 124 to be in contact with at least a portion of inner sealing surface 116 of lower seal 102 and at least a portion of outer sealing surface 118 of lower seal 102 to be in contact with an interior surface of tapered portion 215 of closet collar 210. The weight of toilet horn 202 on upper main seal 106 will also create compression of central body 124 against lower seal 102 and against tapered portion 215 through the connection between threads 166 and threads 136. In other installation embodiments, where there is no contact between upper body 144 and central body 124, the compressive force through the connection between threads 166 and threads 136 may be the only compressive force applied on central body 124 against lower seal 102 and tapered portion 215. The compression of these components together creates a fluid tight seal to aid in preventing fluid leaking from a drainpipe 222 connected to closet collar 210 and from toilet horn 202 in contact with upper main seal 106.

With preferred embodiments of seal assembly 100, it is not necessary to use a wax seal to create a fluid tight seal. Most preferably a wax seal is not used with seal assembly 100.

It will be appreciated that a toilet seal and/or a method of installing a toilet seal as disclosed herein may include one or more of the following examples:
Example 1. A toilet seal comprising: (1) a lower threaded support comprising a flange configured to engage with a closet collar and a first threaded body extending downwardly from the flange; and (2) an upper main seal comprising a sealing surface and a second threaded body extending downwardly from the sealing surface; wherein the first threaded body is configured to engage with the second threaded body to allow a position of the sealing surface to be selectively raised or lowered relative to the flange by rotating one of the first threaded body or the second threaded body relative to the other of the first threaded body or the second threaded body.
Example 2. The toilet seal of example 1 further comprising a lower seal configured to receive at least a portion the lower threaded support and be disposed between the lower threaded support and a portion of the closet collar.
Example 3. The toilet seal of any one of examples 1 to 2 wherein the lower threaded support further comprises a central body disposed between the flange and the first threaded body; and wherein the upper main seal further comprises an upper body disposed between the sealing surface and the second threaded body.
Example 4. The toilet seal of any one of examples 1 to 3 further comprising a lower seal; wherein the central body is configured to receive at least a portion of the upper body; wherein the lower seal is configured to receive at least a portion of the central body and be disposed between the central body and the closet collar.
Example 5. The toilet seal of any one of examples 1 to 4 further comprising a sweep seal disposed on an exterior surface of the second threaded body.
Example 6. The toilet seal of example 1 further comprising a plurality of sets of one or more sweep seals, each of the plurality of sets being circumferentially spaced apart from each other of the plurality of sets around an exterior of the second threaded body.
Example 7. The toilet seal of example 6 wherein each of the plurality of sets comprises two or more sweep seals, wherein at least one of the two or more sweep seals in a first of the plurality of sets is spaced apart vertically from at least one other of the two or more sweep seals in the first of the plurality of sets.
Example 8. The toilet seal of any one of examples 5 to 7 wherein at least one of the plurality of sets comprises an elongated sweep seal, wherein the elongated sweep seal extends from a crest on a first thread of the second threaded body to at least a crest on a second thread of the second threaded body.
Example 9. The toilet seal of any one of examples 5 to 8 wherein at least one of the plurality of sets comprises an elongated sweep seal that extends substantially vertically from an upper end of the second threaded body to a lower end of the second threaded body along a contour of the second threaded body.
Example 10. The toilet seal of any one of examples 1 to 9 wherein the first threaded body comprises a dual thread start configuration and the second threaded body comprises a dual thread start configuration.
Example 11. The toilet seal of any one of examples 1 to 10 wherein the first threaded body comprises a thread pitch of around 0.33333 to 1.33334 inches.
Example 12. The toilet seal of any one of examples 1 to 11 wherein the first threaded body comprises a dual thread start configuration and the second threaded body comprises a dual thread start configuration.
Example 13. The toilet seal of any one of examples 1 to 12 wherein the second threaded body comprises a thread pitch of around 0.33333 to 1.33334 inches.
Example 14. The toilet seal of any one of examples 2 to 13 wherein the lower seal comprises a sealing rib extending outwardly from an outer surface of the lower seal.
Example 15. The toilet seal of any one of examples 1 to 14 wherein no wax seal is used.
Example 16. The toilet seal any one of examples 5 to 15 wherein the sweep seal is compressible and disposed on at least a portion of the second threaded body; wherein the second threaded body comprises a plurality of threads, wherein each thread comprises a plurality of segments each having a profile tolerance and wherein the profile tolerance of at least one of the plurality of segments is not equal to the profile tolerance of at least one other of the plurality of segments.
Example 17. The toilet seal of example 16 wherein the profile tolerances of the plurality of segments are configured to maintain a seal compression of the sweep seal of around 25 to 45% of an original size of the sweep seal when not compressed.
Example 18. A seal for sealing a first component in fluid communication with a second component, the seal comprising: (1) a lower threaded support comprising a flange configured to engage with the first component, a first threaded body extending downwardly from the flange, and a first aperture extending through the flange and the first threaded body; and (2) an upper main seal comprising a sealing surface, a second threaded body extending downwardly from the sealing surface, and a second aperture extending through the sealing surface and the second threaded body; wherein the first threaded body is configured to receive and engage with the second threaded body to allow a position of the sealing surface to be selective raised or lowered relative to the flange by rotating the second threaded body relative to the first threaded body; and wherein the sealing surface is configured to receive the second component.
Example 19. The seal of example 18 further comprising a sweep seal disposed on an exterior surface of the second threaded body.
Example 20. The seal of example 19 wherein the sweep seal is configured to engage with at least a portion of an interior surface of the first threaded body.
Example 21. The seal of any one of examples 18 to 20 wherein the second threaded body comprises a threaded insert that is substantially rigid and a covering disposed on an exterior surface of the threaded insert.
Example 22. The seal of example 21 wherein the covering is compressible.
Example 23. The seal of any one of examples 21 to 22 to wherein the covering is overmolded onto the threaded insert.
Example 24. The seal of example 18 further comprising a plurality of sets of one or more sweep seals, each of the plurality of sets being circumferentially spaced apart from each other of the plurality of sets around an exterior of the second threaded body.
Example 25. The seal of example 24 wherein each of the plurality of sets comprises two or more sweep seals, wherein at least one of the two or more sweep seals in a first of the plurality of sets is spaced apart vertically from at least one other of the two or more sweep seals in the first of the plurality of sets.
Example 26. The seal of any one of examples 24 to 25 wherein at least one of the plurality of sets comprises an elongated sweep seal, wherein the elongated sweep seal extends from a crest on a first thread of the second threaded body to at least a crest on a second thread of the second threaded body.
Example 27. The seal of any one of examples 24 to 26 wherein at least one of the plurality of sets comprises an elongated sweep seal that extends substantially vertically from an upper end of the second threaded body to a lower end of the second threaded body along a contour of the second threaded body.
Example 28. The seal of any one of examples 18 to 27 wherein the first threaded body comprises a dual thread start configuration and the second threaded body comprises a dual thread start configuration.
Example 29. The seal of any one of examples 18 to 28 wherein the first threaded body comprises a thread pitch of around 0.3333 to 1.33334 inches.
Example 30. The seal of any one of examples 18 to 29 further comprising a lower seal configured to receive at least a portion the lower threaded support and be disposed between the lower threaded support and a portion of the first component.
Example 31. The seal of any one of examples 18 to 30 wherein the lower threaded support further comprises a central body disposed between the flange and the first threaded body; and wherein the upper main seal further comprises an upper body disposed between the sealing surface and the second threaded body.
Example 32. The seal of example 31 further comprising a lower seal; wherein the central body is configured to receive at least a portion of the upper body; wherein the lower seal is configured to receive at least a portion of the central body and be disposed between the central body and the first component.
Example 33. The seal any one of examples 19 to 32 wherein the sweep seal is compressible; wherein the second threaded body comprises a plurality of threads, wherein each thread comprises a plurality of segments each having a profile tolerance and wherein the profile tolerance of at least one of the plurality of segments is not equal to the profile tolerance of at least one other of the plurality of segments.
Example 34. The toilet seal of example 33 wherein the profile tolerances of the plurality of segments are configured to maintain a seal compression of the sweep seal of around 25 to 45% of an original size of the sweep seal when not compressed.
Example 35. A method of installing the toilet seal of any one of examples 1-17, the method comprising: placing the lower threaded support into an opening in the closet collar; aligning a mounting hole disposed on the flange with a bolt extending upwardly from the closet collar; and rotating the second threaded body of the upper main seal in the first threaded body of the lower threaded support to selectively position the sealing surface at a desired height above the flange to allow a toilet horn of a toilet positioned on a floor surface around the closet collar to engage with the sealing surface.
Example 36. A method of installing a seal of any one of examples 18-34 between the first component and the second component, the method comprising: placing the lower threaded support into an opening in first component; and rotating the second threaded body of the upper main seal in the first threaded body of the lower threaded support to selectively position the sealing surface at a desired height above or distance from the first component to allow the second component to engage with the sealing surface.

In the foregoing specification, the concepts have been described with reference to specific embodiments or examples, in particular a seal assembly 100 for use with a toilet and closet collar 210. However, those of ordinary skill in the art appreciate that various modifications and changes can be made without departing from the scope of the invention as set forth in the claims below, especially for use of one or more components of seal assembly 100 for sealing other components together. Other examples that occur to those skilled in the art are intended to be within the scope of the claims if they have structural elements that do not differ from the literal language of the claims, or if they include equivalent structural elements with insubstantial differences from the literal languages of the claims. Accordingly, the specification and figures are to be regarded in an illustrative rather than in a restrictive sense, and all such modifications are intended to be included within the scope of the invention.

References to “about” or “around” with respect to dimensions generally mean+/−0.10 inches for dimensions indicated to two decimal places; +/−0.005 for dimensions indicated to three or more decimal places; and +/−1 degree for angles. Further, references to numerical values stated in ranges include each and every value within that range and any and all subset combinations within ranges, including subsets that overlap from one range (or one preferred range) to another range (or a more preferred range) and even if the specific subset of the range is not specifically described herein.

Note that not all of the activities or features described above in the detailed description or in the examples are required, that a portion of a specific activity or feature may not be required, and that one or more further activities or features may be performed in addition to those described. Still further, the order in which activities are listed is not necessarily the order in which they are performed.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: (1) A is true (or present), and B is false (or not present), (2) A is false (or not present), and B is true (or present), and (3) both A and B are true (or present).

Also, the use of “a” or “an” is employed to describe elements and components described herein. This is done merely for convenience and to give a general sense of the scope of the invention. This description should be read to include one or at least one, and the singular also includes the plural unless it is obvious that it is meant otherwise.

After reading the specification, those of ordinary skill in the art will appreciate that certain features that are, for clarity, described herein in the context of separate embodiments, may also be provided in combination in a single embodiment. Conversely, various features that are, for brevity, described in the context of a single embodiment, may also be provided separately or in any subcombination. Any feature, component, element, or method steps of a preferred embodiment herein may be used with any other features, components, elements, or steps of other embodiments even if not specifically described with respect to that embodiment, unless such combination is explicitly excluded herein. Any feature, component, element, or method steps described as excluded with any particular preferred embodiment herein may similarly be excluded with any other preferred embodiment herein even if not specifically described with such embodiment. Any feature, component, element, or method steps described in the prior art that are not described herein may be excluded with any embodiment herein even if not specifically described as excluded with such embodiment.

What is claimed is:

1. A toilet seal comprising:
a lower threaded support comprising a flange configured to engage with a closet collar and a first threaded body extending downwardly from the flange; and
an upper main seal comprising a sealing surface and a second threaded body extending downwardly from the sealing surface;
wherein the first threaded body is configured to engage with the second threaded body to allow a position of the sealing surface to be selectively raised or lowered relative to the flange by rotating one of the first threaded body or the second threaded body relative to the other of the first threaded body or the second threaded body.

2. The toilet seal of claim 1 further comprising a lower seal configured to receive at least a portion the lower threaded support and be disposed between the lower threaded support and a portion of the closet collar.

3. The toilet seal of claim 1 wherein the lower threaded support further comprises a central body disposed between the flange and the first threaded body; and
wherein the upper main seal further comprises an upper body disposed between the sealing surface and the second threaded body.

4. The toilet seal of claim 3 further comprising a lower seal;
wherein the central body is configured to receive at least a portion of the upper body;
wherein the lower seal is configured to receive at least a portion of the central body and be disposed between the central body and the closet collar.

5. The toilet seal of claim 1 further comprising a sweep seal disposed on an exterior surface of the second threaded body.

6. The toilet seal of claim 1 further comprising a plurality of sets of one or more sweep seals, each of the plurality of sets being circumferentially spaced apart from each other of the plurality of sets around an exterior of the second threaded body.

7. The toilet seal of claim 6 wherein each of the plurality of sets comprises two or more sweep seals, wherein at least one of the two or more sweep seals in a first of the plurality of sets is spaced apart vertically from at least one other of the two or more sweep seals in the first of the plurality of sets.

8. The toilet seal of claim 6 wherein at least one of the plurality of sets comprises an elongated sweep seal, wherein the elongated sweep seal extends from a crest on a first thread of the second threaded body to at least a crest on a second thread of the second threaded body.

9. The toilet seal of claim 6 wherein at least one of the plurality of sets comprises an elongated sweep seal that extends substantially vertically from an upper end of the second threaded body to a lower end of the second threaded body along a contour of the second threaded body.

10. The toilet seal of claim 1 wherein the first threaded body comprises a dual thread start configuration and the second threaded body comprises a dual thread start configuration.

11. The toilet seal of claim 10 wherein the first threaded body comprises a thread pitch of around 0.33333 to 1.33334 inches.

12. The toilet seal of claim 5 wherein the first threaded body comprises a dual thread start configuration and the second threaded body comprises a dual thread start configuration.

13. The toilet seal of claim 12 wherein the first threaded body comprises a thread pitch of around 0.33333 to 1.33334 inches.

14. The toilet seal of claim 4 further comprising a sweep seal disposed on an exterior surface of the second threaded body; and
wherein the lower seal comprises a sealing rib extending outwardly from an outer surface of the lower seal.

15. The toilet seal of claim 1 wherein no wax seal is used.

16. The toilet seal of claim 6 wherein no wax seal is used.

17. The toilet seal of claim 14 wherein no wax seal is used.

18. A seal for sealing a first component in fluid communication with a second component, the seal comprising:
a lower threaded support comprising a flange configured to engage with the first component, a first threaded body extending downwardly from the flange, and a first aperture extending through the flange and the first threaded body; and
an upper main seal comprising a sealing surface, a second threaded body extending downwardly from the sealing surface, and a second aperture extending through the sealing surface and the second threaded body;
wherein the first threaded body is configured to receive and engage with the second threaded body to allow a position of the sealing surface to be selective raised or lowered relative to the flange by rotating the second threaded body relative to the first threaded body; and
wherein the sealing surface is configured to receive the second component.

19. The seal of claim 18 further comprising a sweep seal disposed on an exterior surface of the second threaded body.

20. The seal of claim 19 wherein the sweep seal is configured to engage with at least a portion of an interior surface of the first threaded body.

21. The seal of claim 20 wherein the second threaded body comprises a threaded insert that is substantially rigid and a covering disposed on an exterior surface of the threaded insert.

22. The seal of claim 21 wherein the covering is compressible.

23. The seal of claim 21 wherein the covering is overmolded onto the threaded insert.

24. The seal of claim 18 further comprising a plurality of sets of one or more sweep seals, each of the plurality of sets being circumferentially spaced apart from each other of the plurality of sets around an exterior of the second threaded body.

25. The seal of claim 24 wherein each of the plurality of sets comprises two or more sweep seals, wherein at least one of the two or more sweep seals in a first of the plurality of sets is spaced apart vertically from at least one other of the two or more sweep seals in the first of the plurality of sets.

26. The seal of claim 24 wherein at least one of the plurality of sets comprises an elongated sweep seal, wherein the elongated sweep seal extends from a crest on a first thread of the second threaded body to at least a crest on a second thread of the second threaded body.

27. The seal of claim 25 wherein at least one of the plurality of sets comprises an elongated sweep seal that extends substantially vertically from an upper end of the second threaded body to a lower end of the second threaded body along a contour of the second threaded body.

28. The seal of claim 18 wherein the first threaded body comprises a dual thread start configuration and the second threaded body comprises a dual thread start configuration.

29. The seal of claim 28 wherein the first threaded body comprises a thread pitch of around 0.3333 to 1.33334 inches.

30. The seal of claim 18 further comprising a lower seal configured to receive at least a portion the lower threaded support and be disposed between the lower threaded support and a portion of the first component.

31. The seal of claim 18 wherein the lower threaded support further comprises a central body disposed between the flange and the first threaded body; and
wherein the upper main seal further comprises an upper body disposed between the sealing surface and the second threaded body.

32. The seal of claim 31 further comprising a lower seal;
wherein the central body is configured to receive at least a portion of the upper body;
wherein the lower seal is configured to receive at least a portion of the central body and be disposed between the central body and the first component.

33. A method of installing the toilet seal of claim 1, the method comprising:
placing the lower threaded support into an opening a closet collar;
aligning a mounting hole disposed on the flange with a bolt extending upwardly from the closet collar;
rotating the second threaded body of the upper main seal in the first threaded body of the lower threaded support to selectively position the sealing surface at a desired height above the flange to allow a toilet horn of a toilet positioned on a floor surface around the closet collar to engage with the sealing surface.

34. The method of claim 33 wherein the toilet seal further comprises a lower seal, the method further comprising placing the lower seal into the opening of the closet collar such that at least a portion the lower seal disposed between at least a portion of the lower threaded support and a portion of the closet collar.
